(19) United States
(12) Patent Application Publication
(10) Pub. No.: US 2025/0343618 A1
(43) Pub. Date: Nov. 6, 2025

(54) Polarization Diverse Electro-Optic Receiver with Controlled Optical Attenuation

(71) Applicant: Ayar Labs, Inc., San Jose, CA (US)

(72) Inventors: Sidney Buchbinder, Santa Clara, CA (US); Hayk Gevorgyan, San Jose, CA (US); Anatol Khilo, Lexington, MA (US); John M. Fini, Albany, CA (US)

(21) Appl. No.: 19/197,996

(22) Filed: May 3, 2025

Related U.S. Application Data
(60) Provisional application No. 63/642,871, filed on May 5, 2024.

(51) Int. Cl. H04J 14/02; G02B 6/293; H04J 14/06

(52) U.S. Cl. CPC H04J 14/0305; G02B 6/29382; H04J 14/06

(57) ABSTRACT

An electro-optic receiver includes a bus optical waveguide and a plurality of wavelength division multiplexing (WDM) receiver slices positioned along the bus optical waveguide. Each of the plurality of WDM receiver slices includes a WDM element optically coupled to the bus optical waveguide, a photodetector, and a receiver circuit. The photodetector is optically connected to the WDM element by both a first optical connection and a second optical connection. The WDM element conveys a first component of input light through the first optical connection to the photodetector, and a second component of input light through the second optical connection to the photodetector, where first and second components of input light travel in opposite directions through the bus optical waveguide. The receiver circuit generates an electrical data signal from photocurrents received from the photodetector.

### CROSS-REFERENCE TO RELATED APPLICATIONS

This application claims priority under 35 U.S.C. 119(e) to U.S. Provisional Patent Application No. 63/642,871, filed on May 5, 2024, the disclosure of which is incorporated herein by reference in its entirety for all purposes.

### BACKGROUND OF THE INVENTION

### 1. Field of the Invention

The present invention relates to optical data communication.

### 2. Description of the Related Art

Optical data communication systems operate by modulating laser light to encode digital data patterns. The modulated laser light is transmitted through an optical data network from a sending node to a receiving node. The modulated laser light having arrived at the receiving node is de-modulated to obtain the original digital data patterns. Therefore, implementation and operation of optical data communication systems is dependent upon having reliable and efficient devices for modulating optical signals and for receiving optical signals.

Integrating photonic components on a semiconductor chip has many advantages. Integrated photonic chips are a powerful technology for implementing optical data communications links or for providing processing of optical signals, since they allow many optical components to be incorporated on a single chip. A platform that allows close integration between photonic components and circuits provides even greater advantages. Typically, photonic integrated circuits (PICs) have components that are not polarization insensitive, which presents a challenge in how they can process optical signals that enter the PIC in an unknown polarization state. Integrated photonic components are often highly polarization sensitive, while standard single-mode optical fibers that are used for conveying digital data as modulated light signals to and/or from the integrated photonic components is generally not polarization maintaining. In optical data communication systems, it is common for modulated light signals that convey digital data to arrive on an optical fiber at a photonic receiver device in an unknown and uncontrolled mixture of polarization components. In these situations, it is a challenge for the photonic receiver device to process the incoming modulated light signals effectively with polarization-sensitive integrated photonic components. It is within this context that the present invention arises.

### SUMMARY OF THE INVENTION

In an example embodiment, an electro-optic receiver is disclosed. The electro-optic receiver includes a bus optical waveguide. The electro-optic receiver includes a plurality of wavelength division multiplexing (WDM) receiver slices positioned along the bus optical waveguide. Each of the plurality of WDM receiver slices includes a WDM element optically coupled to the bus optical waveguide. Each of the plurality of WDM receiver slices also includes a photodetector. The photodetector of a given WDM receiver slice is optically connected to the WDM element of the given WDM receiver slice by both a first optical connection and a second optical connection. The WDM element of the given WDM receiver slice is configured to convey a first component of input light traveling through the bus optical waveguide in a first direction through the first optical connection to the photodetector. The WDM element of the given WDM receiver slice is configured to convey a second component of input light traveling through the bus optical waveguide in a second direction through the second optical connection to the photodetector. The second direction is opposite of the first direction. Each of the plurality of WDM receiver slices also includes a receiver circuit. The receiver circuit of a given WDM receiver slice is electrically connected to receive a photocurrent from the photodetector of the given WDM receiver slice. The receiver circuit of the given WDM receiver slice is configured to generate an electrical data signal from the photocurrent.

In an example embodiment, an optical signal delay device is disclosed. The optical signal delay device includes an optical waveguide that has a spiral configuration. The spiral configuration has an overall shape that is substantially rectangular as defined by a width and a length that is substantially larger than the width. Adjacently positioned portions of the optical waveguide within the spiral configuration are configured to have an optical index-mismatch of sufficient amount so as to substantially mitigate optical signal crosstalk between the adjacently positioned portions of the optical waveguide.

In an example embodiment, a method is disclosed for initializing an electro-optic receiver. The method includes having an electro-optic receiver that includes a bus optical waveguide and a plurality of WDM receiver slices positioned along the bus optical waveguide. Each of the plurality of WDM receiver slices includes a WDM element optically coupled to the bus optical waveguide. Each of the plurality of WDM receiver slices also includes a photodetector. The photodetector of a given WDM receiver slice is optically connected to the WDM element of the given WDM receiver slice by both a first optical connection and a second optical connection. The WDM element of the given WDM receiver slice is configured to convey a first component of input light traveling through the bus optical waveguide in a first direction through the first optical connection to the photodetector. The WDM element of the given WDM receiver slice is configured to convey a second component of input light traveling through the bus optical waveguide in a second direction through the second optical connection to the photodetector. The second direction is opposite of the first direction. Each of the plurality of WDM receiver slices also includes a receiver circuit. The receiver circuit of a given WDM receiver slice is electrically connected to receive a photocurrent from the photodetector of the given WDM receiver slice. The receiver circuit of the given WDM receiver slice is configured to generate an electrical data signal from the photocurrent. The plurality of WDM receiver slices collectively form a receiver assembly that has a first end and a second end. The electro-optic receiver further includes a first variable optical attenuator optically coupled to the bus optical waveguide at the first end of the receiver assembly. The electro-optic receiver further includes a second variable optical attenuator optically coupled to the bus optical waveguide at the second end of the receiver assembly. The method also includes setting the first variable optical attenuator to provide a high-loss path for return light. The method also includes setting the second variable optical attenuator to allow conveyance of incoming light in the second direction through the bus optical waveguide. The method also includes supplying incoming light of multiple wavelengths to the bus optical waveguide. The method also includes controlling the resonant wavelength of each WDM element of the plurality of WDM receiver slices to ensure that each WDM element is operating within its designated drop wavelength band.

Other aspects and advantages of the disclosed embodiments will become more apparent from the following detailed description, taken in conjunction with the accompanying drawings, illustrating by way of example the disclosed embodiments.

### BRIEF DESCRIPTION OF THE DRAWINGS

FIG. 1 shows an example configuration of an electro-optic receiver, in accordance with some embodiments

FIG. 2 shows an example configuration of the electro-optic receiver of FIG. 1, with a polarization splitter-rotator implemented to convey the first component of input light into a first end of the bus optical waveguide in the first direction, and to convey the second component of input light into a second end of the bus optical waveguide in the second direction, in accordance with some embodiments.

FIG. 3 shows an example configuration of the electro-optic receiver of FIG. 1, with the VOA implemented in a folded configuration, in accordance with some embodiments.

FIG. 4 shows an example configuration of the electro-optic receiver of FIG. 3, with implementation of a first power monitor block and a second power monitor block, in accordance with some embodiments.

FIG. 5A shows an example configuration of the electro-optic receiver of FIG. 1, in which the WDM elements, the PD's, and the receiver circuitry are positioned together within the receiver assembly, in accordance with some embodiments.

FIG. 5B shows an example configuration of the electro-optic receiver of FIG. 1, in which the WDM elements are placed near each other, and in which the PD's and the receiver circuitry are positioned together within the receiver assembly, in accordance with some embodiments.

FIG. 5C shows an example configuration of the electro-optic receiver of FIG. 1, in which the WDM elements and the PD's are placed near each other, so that the longest optical path distance between WDM elements is much smaller than the extent of the row of the WDM receiver slices within the receiver assembly, in accordance with some embodiments.

FIG. 5D shows an example configuration of the electro-optic receiver of FIG. 1, in which the receiver circuitry of the WDM receiver slices are positioned around a central region in which the WDM elements and the PD's are positioned, in accordance with some embodiments.

FIG. 6 shows an example optical waveguide that has a spiral-shaped structure and that is configured to have optical index-mismatch between adjacently positioned portions of the optical waveguide, so as to mitigate optical signal crosstalk, in accordance with some embodiments.

FIG. 7 shows a flowchart of a method for initializing the electro-optic receiver, and for then putting the electro-optic receiver into normal operating mode, in accordance with some embodiments.

FIG. 8A shows a flowchart of a method for initializing the electro-optic receiver, in accordance with some embodiments.

FIG. 8B shows a flowchart of a method for initializing the electro-optic receiver, in accordance with some embodiments.

FIG. 9A shows plots of the effective index for a silicon strip optical waveguide as a function of optical waveguide width for various polarization (TE) modes (TE₁, TE₂, TE₃, and TE₄), in accordance with some embodiments.

FIG. 9B shows plots of the group index for a silicon strip optical waveguide as a function of optical waveguide width for various polarization (TE) modes (TE₁, TE₂, TE₃, and TE₄), in accordance with some embodiments.

FIG. 9C shows plots of the effective index for a silicon nitride strip optical waveguide as a function of optical waveguide width for various polarization (TE) modes (TE₁, TE₂, TE₃, and TE₄), in accordance with some embodiments.

FIG. 9D shows plots of the group index for a silicon nitride strip optical waveguide as a function of optical waveguide width for various polarization (TE) modes (TE₁, TE₂, and TE₃), in accordance with some embodiments.

FIG. 10A shows a top view of the electro-optic receiver incorporated into a co-packaged assembly, in accordance with some embodiments.

FIG. 10B shows the co-packaged assembly, with the optical connectivity solution implemented as an optical waveguide array connector that is directly optically connected to the electro-optic receiver in the PIC, in accordance with some embodiments.

FIG. 10C shows the co-packaged assembly, with the optical connectivity solution built into the co-packaged assembly using an interposer or other packaging component that incorporates optical waveguides and optical couplers, as needed, in accordance with some embodiments.

### DETAILED DESCRIPTION

In the following description, numerous specific details are set forth in order to provide an understanding of the embodiments disclosed herein. It will be apparent, however, to one skilled in the art that the embodiments disclosed herein may be practiced without some or all of these specific details. In other instances, well known process operations have not been described in detail in order not to unnecessarily obscure the disclosed embodiments.

Optical data communication systems operate by modulating laser light to encode digital data patterns within the electrical domain as modulated light signals within the optical domain. The modulated light signals are transmitted through optical fibers to an electro-optic receiver where the modulated light signals are detected and decoded to obtain the original encoded digital data patterns back in the electrical domain. In many optical data communication systems, a polarization state of the light within the optical fiber is not controlled, and may be perturbed by small movements of the optical fiber and/or changes in ambient temperature while the system is operating. In these systems, the electro-optic receiver has to handle incoming light signals that have an arbitrary polarization that varies over time.

Electro-optic receiver systems are often built into photonic integrated circuits (PIC's), enabling compact and high-performance detection of modulated light signals received as input from optical fibers. Optical coupling of light from an optical fiber into a PIC requires an optical coupling configuration that can accept input light from either polarization (for example, transverse electric (TE) or transverse magnetic (TM)) of an optical fiber and output it to one or more optical waveguides on the PIC, and often into a preferred polarization state. In some embodiments disclosed herein, an optical coupling configuration is provided in which incoming light is received through either a dual-polarization vertical grating coupler or an edge coupler and is conveyed into a PIC polarization splitter, which splits the incoming light from the two input optical fiber polarizations (TE and TM) and outputs the incoming light of a first polarization and a second polarization into two separate optical waveguides on the PIC, respectively. Also, in some embodiments, either the first polarization or the second polarization is rotated to the other polarization in route to the two separate optical waveguides on the PIC, such that light having the same polarization is conveyed into each of the two separate optical waveguides on the PIC. If a dual-polarization grating is used, coupling splitting and rotating are not performed by cleanly separated elements; the grating itself performs the combined function of coupling from a beam to two separate on-chip waveguides, typically with each signal propagating in a TE polarization of the respective waveguide. In some implementations, a significant advantage is gained by using optical devices that can efficiently detect optical signals that are split in this way based on polarization. Also, in some implementations, there are further advantages obtained by using one photodiode (such as in a photodetector) for both polarization mode components of the incoming light rather than duplicating the number of photodiodes to provide for separate detection of the two polarization mode components of the incoming light, where such further advantages include decreased complexity of the optical circuitry, reduced detector capacitance per channel, and reduced dark current, which results in increased photodiode/photodetector sensitivity.

Various embodiments are disclosed herein for an electro-optic receiver. The electro-optic receiver enables the detection of optical signals of arbitrary input polarization. As disclosed herein, various architectures for the polarization diverse electro-optic receiver design provide for dense integration, high capacity, and robust initialization. Robust initialization and operation of the electro-optic receiver can be improved by incorporating controllable optical attenuation in the optical path so that wavelength-tuning can be characterized without unwanted optical return. To achieve high capacity and dense integration, the various wavelength-division multiplexed (WDM) electro-optic receiver embodiments disclosed herein are configured to maximize use of chip area dedicated to temporal optical signal delay matching. To this end, in various embodiments, the electro-optic receiver uses a combination of slower (higher group index) optical waveguides in the optical signal delay sections and faster (lower group index) optical waveguides in the main bus optical waveguide.

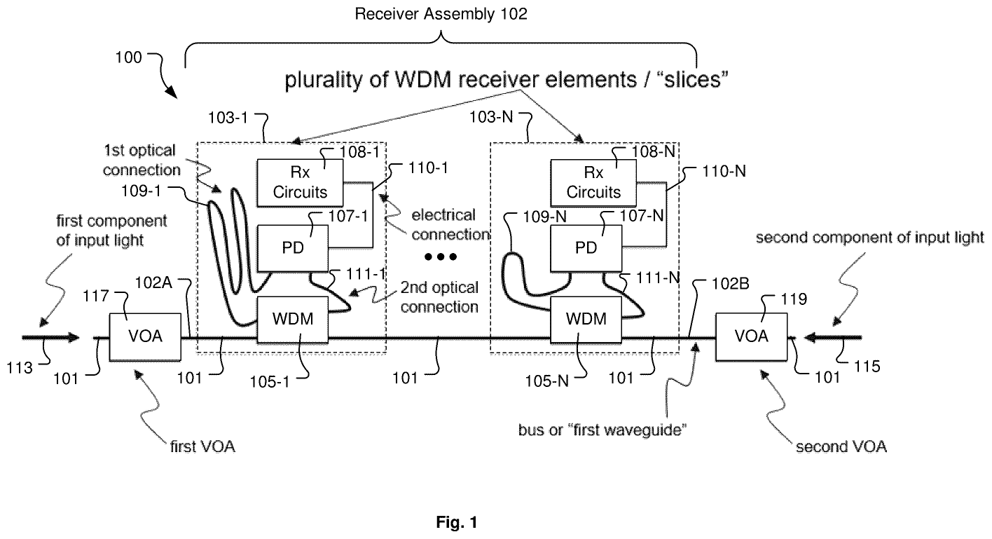

FIG. 1 shows an example configuration of an electro-optic receiver 100, in accordance with some embodiments. The electro-optic receiver 100 includes a bus optical waveguide 101. The electro-optic receiver 100 also includes multiple wavelength division multiplexing (WDM) receiver slices 103-1 to 103-N, where N is an integer number greater than one, positioned along the bus optical waveguide 101. A given WDM receiver slice 103-x, where x is any of 1 to N, includes a WDM element 105-x optically coupled to the bus optical waveguide 101. The WDM element 105-x has a drop wavelength band, such that input light traveling through the bus optical waveguide 101 in each of the two directions of travel that has a wavelength within the drop wavelength band is optically coupled into the WDM receiver slice 103-x by way of the WDM element 105-x. The given WDM receiver slice 103-x also includes a photodetector (PD) 107-x that is optically connected to the WDM element 105-x by both a first optical connection 109-x and a second optical connection 111-x. A first component of input light travels through the bus optical waveguide 101 in a first direction, as indicated by arrow 113. A second component of input light travels through the bus optical waveguide 101 in a second direction, as indicated by arrow 115. The first direction 113 and the second direction 115 are opposite with respect to each other. The WDM element 105-x is configured so that the first component of input light traveling in the first direction 113 is conveyed through the first optical connection 109-x from the WDM element 105-x to the PD 107-x, and so that the second component of input light traveling in the second direction 115 is not conveyed through the first optical connection 109-x from the WDM element 105-x to the PD 107-x. The WDM element 105-x is also configured so that the second component of input light traveling in the second direction 115 is conveyed through the second optical connection 111-x from the WDM element 105-x to the PD 107-x, and so that the first component of input light traveling in the first direction 113 is not conveyed through the second optical connection 111-x from the WDM element 105-x to the PD 107-x. The given WDM receiver slice 103-x also includes receiver circuitry 108-x that is electrically connected to the PD 107-x by way of one or more electrical connections 110-x. The receiver circuitry 108-x is configured to process the photocurrent that is output by the corresponding PD 107-x, so as to convert the optical signal that is detected by the PD 107-x from the optical domain into the electrical domain. In this manner, the receiver circuitry 108-x is configured to generate an electrical data signal from the photocurrent.

The collective grouping of the multiple WDM receiver slices 103-1 to 103-N is referred to as a receiver assembly 102. The receiver assembly 102 has a first end 102A and a second end 102B. A first variable optical attenuator (VOA) 117 is optically coupled to the bus optical waveguide 101 at the first end 102A of the receiver assembly 102. A second VOA 119 is optically coupled to the bus optical waveguide 101 at the second end 102B of the receiver assembly 102. In some embodiments, the VOA 117 and/or the VOA 119 is controlled by a respective circuit that both defines the state of optical attenuation to be provided by the VOA 117/119, and that supplies/controls the electrical current to the VOA 117/119 that is needed to achieve and maintain the defined state of optical attenuation to be provided by the VOA 117/119. In various embodiments, the VOA 117 and/or the VOA 119 is implemented using one or more of a carrier-depletion based device, an interferometer based device (e.g., with thermal phase control of the degree of interference), and essentially any other method/device known in the art for controlling attenuation of optical transmission.

In some embodiments, the WDM elements 105-1 to 105-N, the PD's 107-1 to 107-N, and the receiver circuitry 108-1 to 108-N for the WDM receiver slices 103-1 to 103-N, respectively, exist on a monolithically integrated chip. In these embodiments, an entirety of the receiver assembly 102 is implemented on the same chip. Alternatively, in some embodiments, the WDM elements 105-1 to 105-N and the PD's 107-1 to 107-N for the WDM receiver slices 103-1 to 103-N, respectively, exist on an integrated photonics chip, while the corresponding receiver circuitry 108-1 to 108-N for the WDM receiver slices 103-1 to 103-N, respectively, exist on a separate electronics chip. In some embodiments, the integrated photonics chip is a semiconductor chip, and the electronics chip is a semiconductor chip. In these embodiments, different portions of the receiver assembly 102 are implemented on different chips. In some of these embodiments, the integrated photonics chip and the separate electronics chip are stacked vertically with respect to each other, with electrical connections made vertically between the integrated photonics chip and the separate electronics chip, e.g., made vertically between the PD's 107-1 to 107-N in the integrated photonics chip and the respective receiver circuitry 108-1 to 108-N in the electronics chip. In various embodiments, the vertical electrical connections between the integrated photonics chip and the separate electronics chip are implemented using technologies for dense vertical electrical connectivity of chips with low parasitics, such as one or more of micro-solder bumps, copper-pillars, copper-copper bonding, among others. Additionally, in some embodiments, the circuitry 108-1 to 108-N for the WDM receiver slices 103-1 to 103-N is implemented on both the integrated photonics chip and the separate electronics chip.

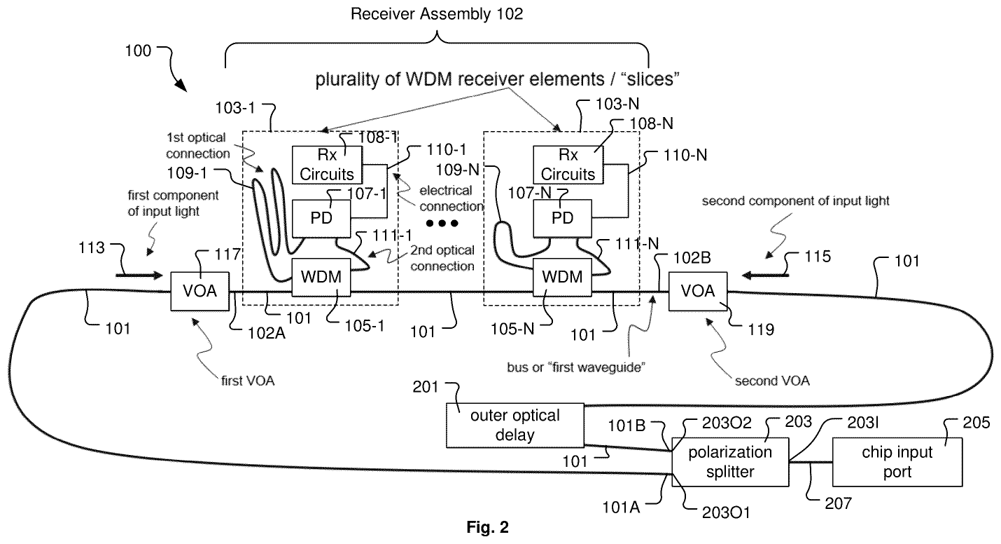

FIG. 2 shows an example configuration of the electro-optic receiver 100 of FIG. 1, with a polarization splitter-rotator 203 implemented to convey the first component of input light into a first end 101A of the bus optical waveguide 101 in the first direction 113, and to convey the second component of input light into a second end 101B of the bus optical waveguide 101 in the second direction 115, in accordance with some embodiments. The polarization splitter-rotator 203 has a first optical output 203O1 optically connected to the first end 101A of the bus optical waveguide 101. The polarization splitter-rotator 203 has a second optical output 203O2 optically connected to the second end 101B of the bus optical waveguide 101. The polarization splitter-rotator 203 has an optical input 203I optically connected to receive input light from a chip optical input port 205 by way of an optical waveguide 207. The polarization splitter-rotator 203 includes a polarization rotation element that is configured to rotate a second polarization of the received input light to a first polarization, such that the first component of input light that is conveyed into the first end 101A of the bus optical waveguide 101 in the first direction 113 has the first polarization, and such that the second component of input light that is conveyed into the second end 101B of the bus optical waveguide 101 in the second direction 115 also has the first polarization. In this manner, both the first component of input light that is traveling in the first direction 113 and the second component of input light that is traveling in the second direction 115 have the first polarization when they reach the WDM elements 105-1 to 105-N of the WDM receiver slices 103-1 to 103-N, respectively. In some embodiments, the first polarization is transverse electric (TE) and the second polarization is transverse magnetic (TM). In some embodiments, the first polarization is TM and the second polarization is TE. In some embodiments, the polarization splitter-rotator 203 is implemented as a single optical device that functions to both optically split the two different polarizations of input light and rotate the second polarization of input light to the first polarization. For example, in some embodiments, the polarization splitter-rotator 203 implements both a polarization-based optical splitter followed by a polarization rotator in a unitary device. In some embodiments, the polarization splitter-rotator 203 is implemented as an assembly of separate optical devices, where one optical device functions to optically split the two different polarizations of input light, and where another optical device functions to rotate the second polarization of input light to the first polarization. For example, in some embodiments, polarization splitter-rotator 203 implements a polarization-based optical splitter as a first device followed by a polarization rotator as a second device.

In some embodiments, the chip optical input port 205 is optically coupled to one or more of an optical fiber, an optical backplane, an interposer, a multi-chip package, and essentially any other optical connectivity device/component/solution. In various embodiments, input light that enters through the chip optical input port 205 has substantially uncontrolled polarization. Uncontrolled variations in polarization of the input light may occur as the input light is transmitted over non-polarization-maintaining fiber(s), such as a standard single mode optical fiber (SMF).

In some embodiments, an outer optical delay element 201 is optically coupled to the bus optical waveguide 101 at a location between the polarization splitter-rotator 203 and the receiver assembly 102. More specifically, in some embodiments, the outer optical delay element 201 is optically coupled to the bus optical waveguide 101 at a location between either the first optical output 203O1 or the second optical output 203O2 and the WDM elements 105-1 to 105-N of the WDM receiver slices 103-1 to 103-N, respectively, in order to mitigate the optical signal timing skew at the PD's 107-1 to 107-N, respectively. The optical timing skew in this context is the relative delay between optical signals of each polarization (TE and TM) of a given portion of the input light of a given wavelength upon reaching a given PD 107-x. Therefore, the optical signal timing skew is a difference in arrival time at a given PD 107-1 to 107-N between a particular wavelength of the first component of input light derived from a given portion of incoming light and the same particular wavelength of the second component of input light derived from the same given portion of incoming light.

The outer optical delay element 201 reduces a need for implementation of large optical signal delay elements in the WDM receiver slices 103-1 to 103-N. In some embodiments, the outer optical delay element 201 is configured so that the first component of input light that is conveyed into the first end 101A of the bus optical waveguide 101 in the first direction 113 and the second component of input light that is conveyed into the second end 101B of the bus optical waveguide 101 in the second direction 115 arrive at a given WDM element 105-x within the receiver assembly 102 at substantially the same time, where the given WDM element 105-x is resonance wavelength-tuned to in-couple the wavelength of the input light. In the embodiments in which the outer optical delay element 201 is positioned along the bus optical waveguide 101 between the second optical output 203O2 of the polarization splitter-rotator 203 and the receiver assembly 102, the outer optical delay element 201 and the VOA 119 can be positioned along the bus optical waveguide 101 in any order. Also, in some embodiments, the outer optical delay element 201 is positioned along the bus optical waveguide 101 between the first optical output 203O1 of the polarization splitter-rotator 203 and the receiver assembly 102. In these embodiments, the outer optical delay element 201 and the VOA 117 can be positioned along the bus optical waveguide 101 in any order. In some embodiments, multiple outer optical delay elements, e.g., 201, are optically coupled to the bus optical waveguide. For example, in some embodiments, a first outer optical delay element is optically coupled to the bus optical waveguide 101 at a location between the first optical output 203O1 of the polarization splitter-rotator 203 and the receiver assembly 102, and a second outer optical delay element is optically coupled to the bus optical waveguide 101 at a location between the second optical output 203O2 of the polarization splitter-rotator 203 and the receiver assembly 102.

In various embodiments, mitigation of the optical signal timing skew at the PD's 107-1 to 107-N is achieved using optical delay provided by multiple optical elements optically coupled to the bus optical waveguide. For example, in some embodiments, a combination of optical delays provided by the outer optical delay element 201, the VOA 117, and the VOA 119 collectively provide for mitigation of the optical signal timing skew at the PD's 107-1 to 107-N. In some embodiments, the VOA 117 and/or the VOA 119 is configured to have substantial optical path length, which can impart an effective optical signal delay.

Each of the WDM elements 105-1 to 105-N has a respective optical drop wavelength that is electrically controlled. In some embodiments, a given WDM element 105-x has an optical drop wavelength that is thermally tuned using a heating element disposed near a wavelength-selective device in the given WDM element 105-x. In these embodiments, the corresponding receiver circuit 108-x includes a resonant wavelength tuning circuit that is configured to control the heating element associated with the WDM element 105-x in order to achieve and maintain operation of the given WDM element 105-x at a target resonance optical wavelength corresponding to the optical drop wavelength, such that light traveling through the bus optical waveguide 101 having the optical drop wavelength is optically coupled into the WDM element 105-x. In various embodiments, the given WDM element 105-x includes one or more thermal isolating structures, such as an undercut region formed to provide thermal isolation. In some embodiments, the wavelength-selective device in the given WDM element 105-x is a microring resonator structure. In some of these embodiments, the heating element for resonant wavelength tuning of the given WDM element 105-x is positioned within an interior region of the microring resonator structure (inside of the inner diameter of the microring resonator structure). Alternatively, in some embodiments, the heating element for resonant wavelength tuning of the given WDM element 105-x is positioned outside of the microring resonator structure (outside of the outer diameter of the microring resonator structure). In some embodiments, the heating element for resonant wavelength tuning of the given WDM element 105-x is an electrical resistance heating device spatially configured and positioned sufficiently close the microring resonator structure of the given WDM element 105-x so that the temperature of the microring resonator structure of the given WDM element 105-x is selectively and independently controllable (upward and/or downward), and so that operation of the electrical resistance heating device for controlling the WDM element 105-x does not interfere with operation of others of the WDM elements 105-1 to 105-N. In some embodiments, the heating element for resonant wavelength tuning of the given WDM element 105-x provides for selective elevation of the temperature of the microring resonator structure of the given WDM element 105-x relative to other regions of the receiver assembly 102. In some embodiments, a given WDM element 105-x is a microring filter.

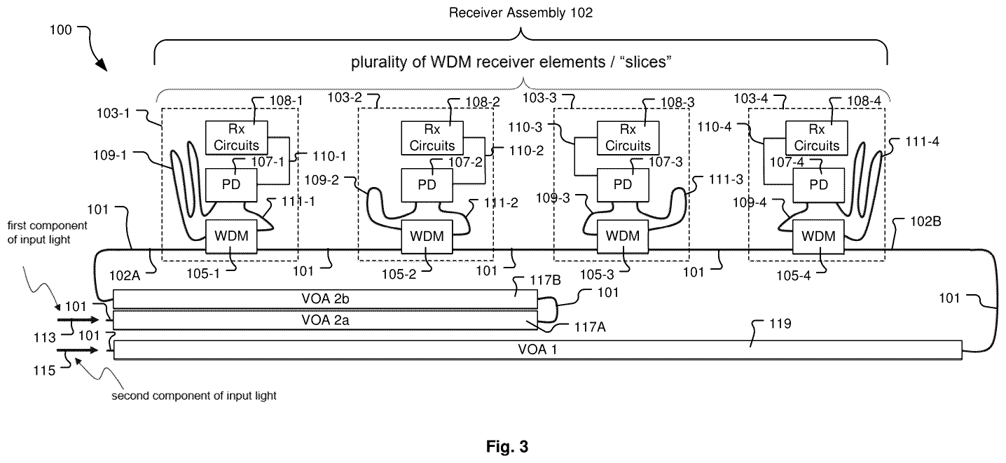

FIG. 3 shows an example configuration of the electro-optic receiver 100 of FIG. 1, with the VOA 117 implemented in a folded configuration, in accordance with some embodiments. A VOA needs to have a substantial optical path length in order to achieve a large range of optical attenuation at low voltage. Therefore, in some embodiments, configuration of the electro-optic receiver 100 to have at least one of the VOA 117 and the VOA 119 run alongside the bus optical waveguide 101 provides advantages with regard to floor-planning of the electro-optic receiver 100 on the chip, e.g., provides for increased compactness of the electro-optical receiver 100 footprint on the chip.

In the example electro-optic receiver 100 of FIG. 3, both the VOA 117 and the VOA 119 run along the direction of bus optical waveguide 101, with the VOA 117 having the folded configuration, and with the VOA 119 having a non-folded configuration. It should be noted that in the example electro-optic receiver 100 of FIG. 3, the bus optical waveguide 101 is configured so that both the first component of input light that travels from the first optical output 203O1 of the polarization splitter-rotator 203 in the first direction 113 and the second component of input light that travels from the second optical output 203O2 of the polarization splitter-rotator 203 in the second direction 115 enter the optical circuit of the electro-optic receiver 100 from a same side of the receiver assembly 102 (from the left side as shown by way of example in FIG. 3). In the example embodiment of FIG. 3, the VOA 119 has a substantially straight configuration. The VOA 117 is folded into a first VOA section 117A and a second VOA section 117B. The bus optical waveguide 101 includes a U-shaped portion that extends between the first VOA section 117A and the second VOA section 117B to enable the folded configuration of the VOA 117. In some embodiments, each of the first VOA section 117A and the second VOA section 117B has a length that is approximately one-half of the length of the VOA 119. Also, in some embodiments, the combined optical path length of the first VOA section 117A and the second VOA section 117B is substantially equal to the optical path length of the VOA 119. Alternatively, in some embodiments, the first VOA section 117A and the second VOA section 117B are collectively configured so that their combined optical path length is intentionally different than the optical path length of the VOA 119. In some embodiments, a difference between the optical path length of the VOA 119 and the combined optical path length of the first VOA section 117A and the second VOA section 117B is defined to temporally compensate for other optical signal delays that are present along the total optical path between the polarization splitter-rotator 203 and the receiver assembly 102. In some embodiments, portions of VOA 117 (VOA section 117A+VOA section 117B) and portions of VOA 119 that are intended to contribute equal and opposite optical signal delays are designed in a substantially equivalent manner, so as to advantageously provide for optical signal delay-matching performance that is more predictable and less sensitive to manufacturing variation, temperature, strain, etc.

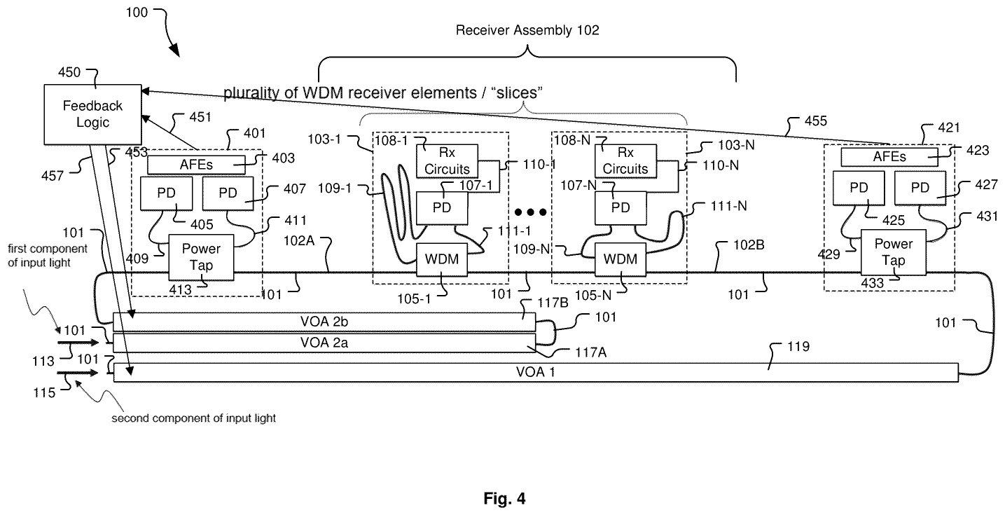

FIG. 4 shows an example configuration of the electro-optic receiver 100 of FIG. 3, with implementation of a first power monitor block 401 and a second power monitor block 421, in accordance with some embodiments. The first power monitor block 401 includes an optical power tap 413 that is optically coupled to the bus optical waveguide 101. In various embodiments, the optical power tap 413 is implemented as an evanescent optical coupler, a multimode interference coupler (MMI), or essentially any other type of optical power tap device. In some embodiments, the optical power tap 413 is configured to provide a broadband or relatively wavelength insensitive response. In some embodiments, the optical power tap 413 is bi-directional, so that the optical power tap 413 can be used to provide information about both the input optical power traveling through the bus optical waveguide 101 past the optical power tap 413 in the first direction 113, and the return optical power traveling through the bus optical waveguide 101 past the optical power tap 413 in the second direction 115. The first power monitoring block 401 also includes PD's 405 and 407. The PD 405 is optically connected to the optical power tap 413 through an optical connection 409, e.g., optical waveguide and/or optical fiber. The PD 407 is optically connected to the optical power tap 413 through an optical connection 411, e.g., optical waveguide and/or optical fiber. In some embodiments, the optical power tap 413 is configured to direct a portion of tapped light traveling through the bus optical waveguide 101 in the first direction 113 through the optical connection 409 to the PD 405, and to direct a portion of tapped light traveling through the bus optical waveguide 101 in the second direction 115 through the optical connection 411 to the PD 407.

The first power monitor block 401 also includes analog front-end (AFE) circuitry 403 for processing the photocurrents generated by each of the PD's 405 and 407. In some embodiments, the AFE 403 is of significantly slower bandwidth than the main optical signal path. In various embodiments, the AFE 403 is configured to provide one or more of optical power monitoring, optical link status, electro-optic receiver 100 control signals, among other functions. In some embodiments, the output of the AFE 403 is conveyed to feedback logic 450, as indicated by arrow 451. In some embodiments, the feedback logic 450 is implemented on a same chip as the electro-optic receiver 100. In some embodiments, the feedback logic 450 is exposed to enable external/remote control. In various embodiments, the feedback logic 450 is implemented as digital circuitry and/or analog circuitry. The first power monitor block 401 provides for optical power monitoring and for corresponding implementation of feedback loops, by way of the feedback logic 450, for controlling operation of the electro-optic receiver 100.

The second power monitor block 421 includes an optical power tap 433 that is optically coupled to the bus optical waveguide 101. In various embodiments, the optical power tap 433 is implemented as an evanescent optical coupler, a multimode interference coupler (MMI), or essentially any other type of optical power tap device. In some embodiments, the optical power tap 433 is configured to provide a broadband or relatively wavelength insensitive response. In some embodiments, the optical power tap 433 is bi-directional, so that the optical power tap 433 can be used to provide information about both the input optical power traveling through the bus optical waveguide 101 past the optical power tap 433 in the second direction 115, and the return optical power traveling through the bus optical waveguide 101 past the optical power tap 433 in the first direction 113. The second power monitoring block 421 also includes PD's 425 and 427. The PD 425 is optically connected to the optical power tap 433 through an optical connection 429, e.g., optical waveguide and/or optical fiber. The PD 427 is optically connected to the optical power tap 433 through an optical connection 431, e.g., optical waveguide and/or optical fiber. In some embodiments, the optical power tap 433 is configured to direct a portion of tapped light traveling through the bus optical waveguide 101 in the second direction 115 through the optical connection 429 to the PD 425, and to direct a portion of tapped light traveling through the bus optical waveguide 101 in the first direction 113 through the optical connection 431 to the PD 427. The second power monitor block 421 also includes AFE circuitry 423 for processing the photocurrents generated by each of the PD's 425 and 427. In some embodiments, the AFE 423 is of significantly slower bandwidth than the main optical signal path. In various embodiments, the AFE 423 is configured to provide one or more of optical power monitoring, optical link status, electro-optic receiver 100 control signals, among other functions. In some embodiments, the output of the AFE 423 is conveyed to the feedback logic 450, as indicated by arrow 455. The second power monitor block 421 provides for optical power monitoring and for corresponding implementation of feedback loops, by way of the feedback logic 450, for controlling operation of the electro-optic receiver 100.

In some embodiments, the feedback logic 450 is configured to generate and transmit electrical control signals to the VOA 117, as indicated by arrow 453. In some embodiments, the feedback logic 450 is configured to generate and transmit electrical control signals to the VOA 119, as indicated by arrow 457. In some embodiments, one or both of the first power monitor block 401 and the second power monitor block 421 is/are used to set overall optical power levels reaching the WDM elements 105-1 to 105-N by adjustment of the VOA 117 and/or VOA 119 settings. In some embodiments, one or both of the first power monitor block 401 and the second power monitor block 421 is/are used to control the respective resonant wavelength tuner settings of the WDM elements 105-1 to 105-N. In some embodiments, the first power monitor block 401 and the second power monitor block 421 are used to determine which of the VOA 117 and the VOA 119 is to be used first in a WDM alignment algorithm. In some embodiments, the first power monitor block 401 and the second power monitor block 421 are used to monitor and control the strength of light (optical power) returned back to the chip optical input port 205.

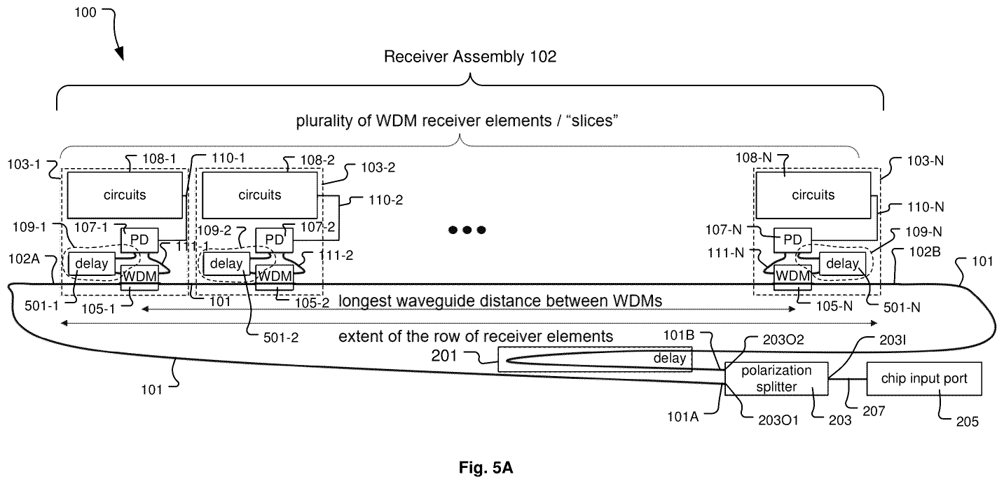

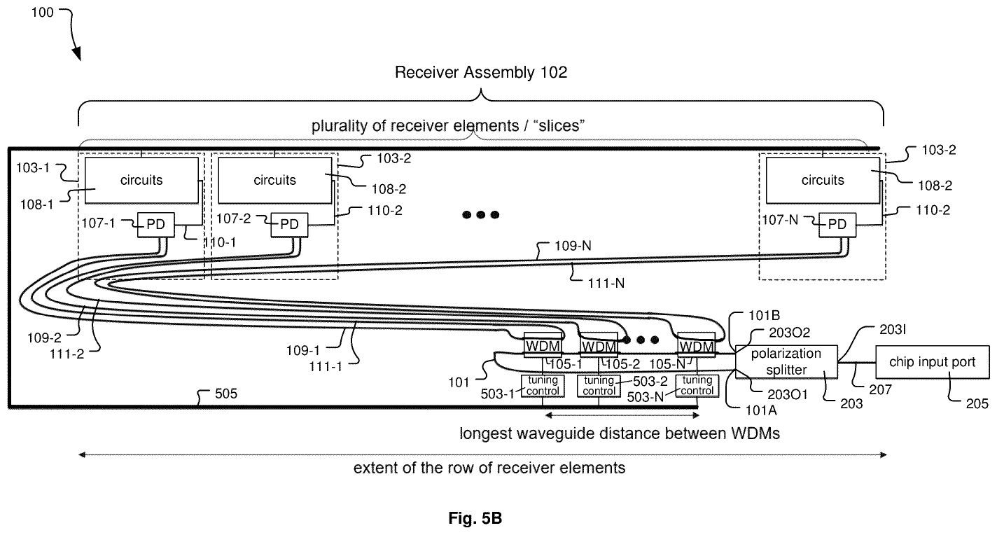

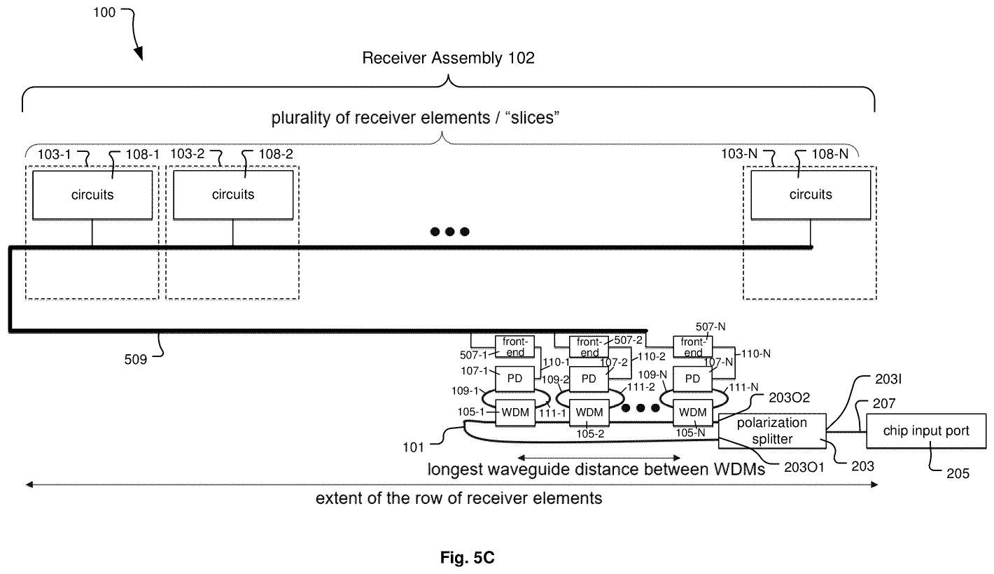

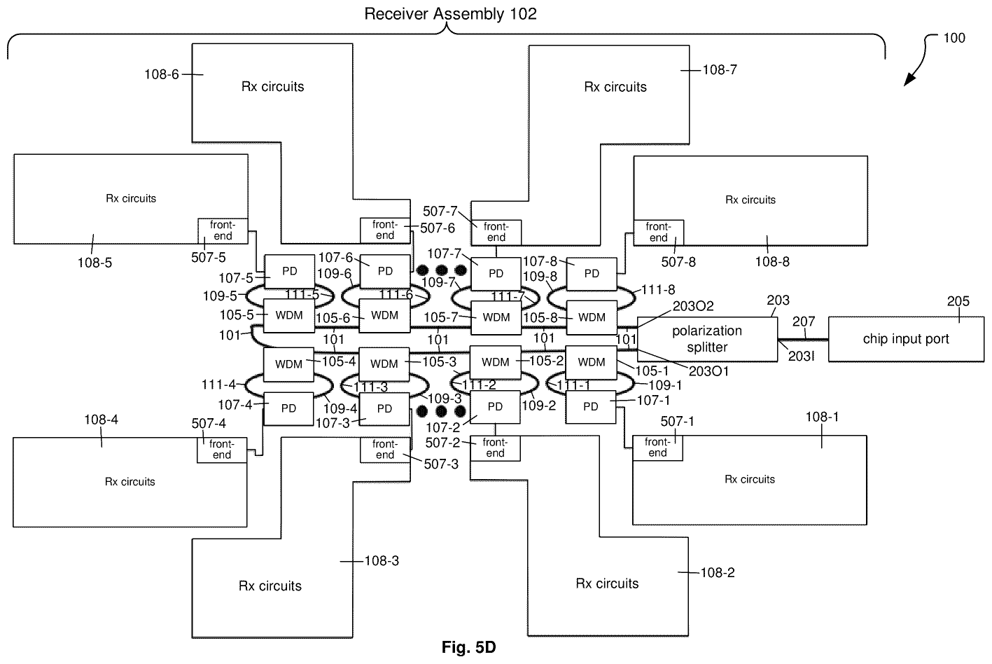

FIG. 5A shows an example configuration of the electro-optic receiver 100 of FIG. 1, in which the WDM elements 105-1 to 105-N, the PD's 107-1 to 107-N, and the receiver circuitry 108-1 to 108-N are positioned together within the receiver assembly 102, in accordance with some embodiments. The first optical connections 109-1 to 109-N of the WDM receiver slices 103-1 to 103-N, respectively, include optical signal delay elements 501-1 to 501-N, respectively. The amount of optical signal delay provided by a given optical signal delay element 501-x is roughly proportional to the optical path distance along the bus optical waveguide 101 between a first WDM element 105-1 or 105-N encountered by the optical signal and the WDM element 105-x corresponding to the optical signal delay element 501-x. The largest such optical path distance is approximately equal to the extent of the row of WDM receiver slices 103-1 to 103-N within the receiver assembly 102 along the bus optical waveguide 101, which can be large if there are many WDM receiver slices 103-1 to 103-N within the receiver assembly 102. Optimization (minimization) of the width (distance along the bus optical waveguide 101) of each of the WDM receiver slices 103-1 to 103-N can be limited by a number of factors, such as the chip area required for the corresponding receiver circuitry 108-1 to 108-N.

FIG. 5B shows an example configuration of the electro-optic receiver 100 of FIG. 1, in which the WDM elements 105-1 to 105-N are placed near each other, and in which the PD's 107-1 to 107-N and the receiver circuitry 108-1 to 108-N are positioned together within the receiver assembly 102, in accordance with some embodiments. In the electro-optic receiver 100 configuration of FIG. 5B, the longest optical path distance between the WDM elements 105-1 to 105-N is much smaller than the total physical extent of the WDM receiver slices 103-1 to 103-N within the receiver assembly 102. In the electro-optic receiver 100 configuration of FIG. 5B, the optical signal delay associated with the optical signal path distance along the bus optical waveguide 101 between WDM elements 105-1 to 105-N is now much smaller, so that the need to temporally compensate for optical signal delay, such as through use of optical signal delay elements 501-1 to 501-N, is substantially relaxed. In the electro-optic receiver 100 configuration of FIG. 5B, at least some the WDM element 105-x-to-PD 107-x optical connections 109-x and/or 111-x can be long. In some embodiments, the first optical connection 109-x and the second optical connection 111-x for a given WDM element 105-x are routed on-chip as an optical waveguide pair along most of the optical signal path distance between the WDM element 105-x and the corresponding PD 107-x, such that optical signal delay matching along this optical signal path distance is more easily controlled.

The electro-optic receiver 100 configuration of FIG. 5B shows an electrical signal bus 505 that electrically and independently/separately connects the receiver circuitry 108-1 to 108-N of the WDM receiver slices 103-1 to 103-N, respectively, to resonant wavelength tuning circuitry 503-1 to 503-N, respectively, of the corresponding WDM elements 105-1 to 105-N, respectively. The resonant wavelength tuning circuitry 503-x of a given WDM element 105-x is configured to control the resonant wavelength of the microring resonator of the given WDM element 105-x. In some embodiments, the resonant wavelength tuning circuitry 503-x is configured to drive a heating device to adjust the drop wavelength of the corresponding WDM element 105-x. In some embodiments, a control signal for directing operation of the resonant wavelength tuning circuitry 503-x of the WDM element 105-x is derived from the photocurrent generated by the corresponding PD 107-x, and is communicated to the resonant wavelength tuning circuitry 503-x through associated electrical connections within the electrical signal bus 505. In some embodiments, communication of the control signal for directing operation of the resonant wavelength tuning circuitry 503-x is done in a digital manner. The communication of the control signal for directing operation of the resonant wavelength tuning circuitry 503-x is done in a manner that is not sensitive to the distance between the receiver circuitry 108-x and the resonant wavelength tuning circuitry 503-x/WDM element 105-x.

FIG. 5C shows an example configuration of the electro-optic receiver 100 of FIG. 1, in which the WDM elements 105-1 to 105-N and the PD's 107-1 to 107-N are placed near each other, so that the longest optical path distance between WDM elements 105-1 to 105-N is much smaller than the extent of the row of the WDM receiver slices 103-1 to 103-N within the receiver assembly 102, in accordance with some embodiments. The optical signal delay associated with the optical signal path distance between WDM elements 105-1 to 105-N is smaller in the electro-optic receiver 100 configuration of FIG. 5C. Also, in the electro-optic receiver 100 configuration of FIG. 5C, the optical signal path lengths of the first optical connections 109-1 to 109-N and the second optical connections 111-1 to 111-N between the WDM elements 105-1 to 105-N and the PD's 107-1 to 107-N, respectively, are smaller. In some embodiments, at a high optical bitrate, timely transmission of high-speed electrical signals from the PD's 107-1 to 107-N to the corresponding receiver circuitry 108-1 to 108-N will be a challenge. To address this challenge, front-end circuits 507-1 to 507-N are implemented spatially near to the corresponding PD's 107-1 to 107-N, while other receiver circuits remain within the corresponding receiver circuitry 108-1 to 108-N in the row of WDM receiver slices 103-1 to 103-N within the receiver assembly 102. In some embodiments, each of the front-end circuits 507-1 to 507-N is independently and separately electrically connected to the corresponding receiver circuitry 108-1 to 108-N through an electrical connection bus 509. In some embodiments, each of the front-end circuits 507-1 to 507-N includes a transimpedance amplifier and an analog-to-digital converter. In some embodiments, each of the front-end circuits 507-1 to 507-N provides for substantially instantaneous transmission of electrical signals from the PD's 107-1 to 107-N to the corresponding receiver circuitry 108-1 to 108-N.

FIG. 5D shows an example configuration of the electro-optic receiver 100 of FIG. 1, in which the receiver circuitry 108-1 to 108-N of the WDM receiver slices 103-1 to 103-N are positioned around a central region in which the WDM elements 105-1 to 105-N and the PD's 107-1 to 107-N are positioned, in accordance with some embodiments. The electro-optic receiver 100 configuration of FIG. 5D is designed to manage the conflicting needs of keeping the optical waveguide distance between WDM elements 105-1 to 105-N small (to avoid large optical signal delay), while providing enough chip area for all of the receiver circuitry 108-1 to 108-N. In the electro-optic receiver 100 configuration of FIG. 5D, the WDM receiver slices 103-1 to 103-N are no longer arranged in a row, but are instead positioned around the central region that includes the WDM elements 105-1 to 105-N and the PD's 107-1 to 107-N. In the electro-optic receiver 100 configuration of FIG. 5D, the WDM elements 105-1 to 105-N and the corresponding PD's 107-1 to 107-N are positioned in a substantially uniform azimuthal arrangement about the central region. It should be understood that the example configurations of FIGS. 5B-5D represent examples of disaggregating the WDM within the electro-optic receiver 100.

An electro-optic receiver that implements compensation for large optical signal delays faces the challenge of fitting a large optical signal delay device into a compact space without introducing optical signal impairments such as crosstalk. In some embodiments, an optical waveguide having a spiral-shaped structure or similar shaped structure will have long stretches of the optical waveguide in close proximity to each other. Therefore, with the spiral-shaped optical waveguide, a tradeoff exists between achieving substantial compactness (by having small separation between adjacent spiral sections of the optical waveguide) and maintaining low optical signal crosstalk between adjacent spiral sections of the optical waveguide. To improve this tradeoff, optical index-mismatch can be introduced between adjacently positioned portions of the optical waveguide, so that optical signal crosstalk is mitigated by an absence of phase-matching.

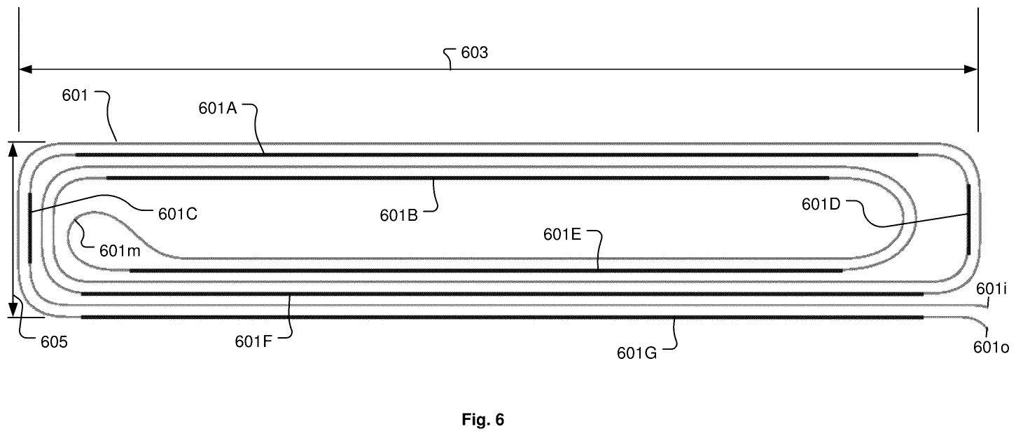

FIG. 6 shows an example optical waveguide 601 that has a spiral-shaped structure and that is configured to have optical index-mismatch between adjacently positioned portions of the optical waveguide 601, so as to mitigate optical signal crosstalk, in accordance with some embodiments. The optical waveguide 601 is configured to have thicker (larger width) sections 601A-601G along its length, such that adjacently positioned sections of the optical waveguide 601 have different thicknesses (widths), and thus have different (mismatched) optical indexes, which serves to mitigate optical signal crosstalk between the adjacently positioned sections of the optical waveguide 601. In some embodiments, the thicker sections 601A-601G of the optical waveguide 601 can have their width tapered up to a larger size than their neighboring portions of the optical waveguide 601 so as to raise the effective index of light guided in them. It should be understood that the spiral-shaped optical waveguide 601 having differing widths in neighboring portions, as shown by way of example in FIG. 6, is one of various possible approaches for improving the tradeoff between crosstalk and compactness. In various embodiments, to achieve a required optical signal delay with sufficiently mitigated crosstalk and optimized compactness, the electro-optic receiver 100 can implement one or more of the optical waveguide 601, an optical waveguide array with submicron pitch, a superlattice array, an optical waveguide with nano-structured cloaking elements, and/or another optical waveguide structure.

The optical waveguide 601 has a spiral configuration, where the spiral configuration has an overall shape that is substantially rectangular as defined by a width 605 and a length 603 that is substantially larger than the width 605. Adjacently positioned portions of the optical waveguide 601 within the spiral configuration are configured to have an optical index-mismatch of sufficient amount so as to substantially mitigate optical signal crosstalk between the adjacently positioned portions of the optical waveguide 601. The optical waveguide 601 has an input end 601i and an output end 601o. The input end 601i and the output end 601o are positioned next to each other at an outer perimeter of the spiral configuration. A first half of the optical waveguide 601 runs parallel and adjacent to a second half of the optical waveguide 601 around the spiral configuration. A midpoint 601m of an overall optical path length of the optical waveguide 601 is located at a center of the spiral configuration. Adjacently positioned portions of the optical waveguide 601 have different widths to achieve the optical index-mismatch. The optical waveguide 601 includes tapers to transition between different widths along an optical path length of the optical waveguide 601. It should be understood that the optical waveguide 601 can be used to implement any of the optical signal delay elements 501-1 to 501-N, and/or any other optical signal delay element mentioned herein.

The various embodiments of the electro-optic receiver 100 disclosed herein enable a procedure for initializing the electro-optic receiver 100 while preventing large optical signal return to propagate backwards out of the electro-optic receiver 100 input port. The polarization-diverse electro-optic receiver 100 has an optical return path by which light entering the polarization splitter-rotator 203 can loop through the bus optical waveguide 100 and return back through the polarization splitter-rotator 203 in the opposite direction. For example, for light output from the first optical output 203O1 of the polarization splitter-rotator 203, a portion of the light may pass the WDM elements 105-1 to 105-N and continue on through the bus optical waveguide 101, passing backwards through the second optical output 203O2 of the polarization splitter-rotator 203. In a similar manner, for light output from the second optical output 203O2 of the polarization splitter-rotator 203, a portion of the light may pass the WDM elements 105-1 to 105-N and continue on through the bus optical waveguide 101, passing backwards through the first optical output 203O1 of the polarization splitter-rotator 203. Return light from the electro-optic receiver 100 can cause system impairments, instabilities, and/or damage through several different possible mechanisms. For example, light returned from the electro-optic receiver 100 into a laser source can de-stabilize the laser or degrade its linewidth.

The light return from the electro-optic receiver 100 is more severe before the electro-optic receiver 100 is initialized, since the WDM elements 105-1 to 105-N are not locked to their resonant optical signal wavelengths and may present low optical loss to the light traveling through the bus optical waveguide 101. In general, the return signal is acceptable once the electro-optic 100 receiver is in a normal operating mode (e.g., processing received optical signals from the optical domain into the electrical domain), because in the normal operating mode the WDM elements 105-1 to 105-N are dropping a substantial portion of the input light that travels through the bus optical waveguide 101, thus allowing relatively little of the input light to pass by all of the WDM elements 105-1 to 105-N to form a return signal. However, before or during initialization of the electro-optic receiver 100, when the resonant operating wavelengths of the WDM elements 105-1 to 105-N are not yet tuned, the WDM elements 105-1 to 105-N may be dropping very little of the light that is conveyed through the bus optical waveguide 101.

The electro-optical receiver 100 configuration and the associated methods of operation disclosed herein address the problem of return light occurring before the WDM element 105-1 to 105-N are locked/tuned to their target resonant wavelength (fully initialized). Impairments due to return light can be mitigated using the VOA 117 and/or the VOA 119. However, in order to initialize a link, sufficient light must be allowed to reach the WDM elements 105-1 to 105-N by way of the bus optical waveguide 101. If the polarization of input light is not controlled, optical power can enter the bus optical waveguide 101 entirely through one of the first end 101A and the second end 101B, or in any ratio between the first end 101A and the second end 101B. Therefore, a challenge exists in that for different input polarizations, a single VOA 117 setting and/or a single VOA 119 setting cannot simultaneously provide both low loss of input light to the WDM elements 105-1 to 105-N for resonant wavelength locking and high loss of input light for ensuring sufficiently low return light.

The polarization-diverse electro-optic receiver 100 is able to utilize one or both of two control states to ensure that each of the WDM elements 105-1 to 105-N can initialize while simultaneously preventing unacceptable return light caused by an excessively low-loss path through the bus optical waveguide 101. In a first of the two control states, the first VOA 117 is controlled to allow the first component of input light (corresponding to the first polarization of the originally received input light) that is conveyed into the first end 101A of the bus optical waveguide 101 in the first direction 113 to propagate with low attenuation to the WDM elements 105-1 to 105-N, while the second VOA 119 is controlled to substantially attenuate the first component of input light so as to prevent any portion of the first component of input light from passing through the bus optical waveguide 101 to reach the second end 101B of the bus optical waveguide 101. In a second of the two control states, the second VOA 119 is controlled to allow the second component of input light (corresponding to the second polarization of the originally received input light) that is conveyed into the second end 101B of the bus optical waveguide 101 in the second direction 115 to propagate with low attenuation to the WDM elements 105-1 to 105-N, while the first VOA 117 is controlled to substantially attenuate the second component of input light so as to prevent any portion of the second component of input light from passing through the bus optical waveguide 101 to reach the first end 101A of the bus optical waveguide 101.

It should be appreciated that implementation of both the first VOA 117 and the second VOA 119 with the electro-optic receiver 100 provides various advantages. For example, if an optical data communication system within which the electro-optic receiver 100 is implemented has polarization-dependent optical loss, this polarization-dependent optical loss will show up as an unequal transmission of light from the input of the electro-optic receiver 100 to the WDM elements 105-1 to 105-N, depending on which polarization the input light has upon entering the electro-optic receiver 100, or equivalently depending on which one of the first optical output 203O1 and the second optical output 203O2 that the input light is conveyed through upon exiting the polarization splitter-rotator 203. This unequal transmission of light from the input of the electro-optic receiver 100 to the WDM elements 105-1 to 105-N can be compensated for by introducing a balancing optical loss in the higher-transmission optical path, such as by controlling one of the first VOA 117 and the second VOA 119. Polarization-dependent optical loss can be associated with time-fluctuations of received optical power. The electro-optic receiver 100 implementing the two VOA's 117 and 119 can be operated to mitigate the polarization-dependent optical loss associated with the time-fluctuations of received optical power, and thereby improve system performance and stability.

Additionally, in some embodiments, the electro-optic receiver 100 may operate best when optical power incident on the PD's 107-1 to 107-N remains below a designated maximum value, so as to avoid saturation in the associated receiver circuitry 108-1 to 108-N. The VOA (VOA 117 or VOA 119) upstream of the WDM elements 105-1 to 105-N can be used to keep the optical power at the PD's 107-1 to 107-N in a desired range, such as by introducing optical loss when the optical power incident on the PD's 107-1 to 107-N would be too high. In various embodiments, a feedback circuit including the power monitor block(s) 401 and/or 421 and the feedback logic 450, as discussed with regard to FIG. 4, and/or an initialization routine for the electro-optic receiver 100 can be used to set the optical power at the WDM elements 105-1 to 105-N at a desired value. In various embodiments, the photocurrent detected by the power monitor block(s) 401 and/or 421 can be utilized by the feedback logic 450 and/or initialization routine, as needed.

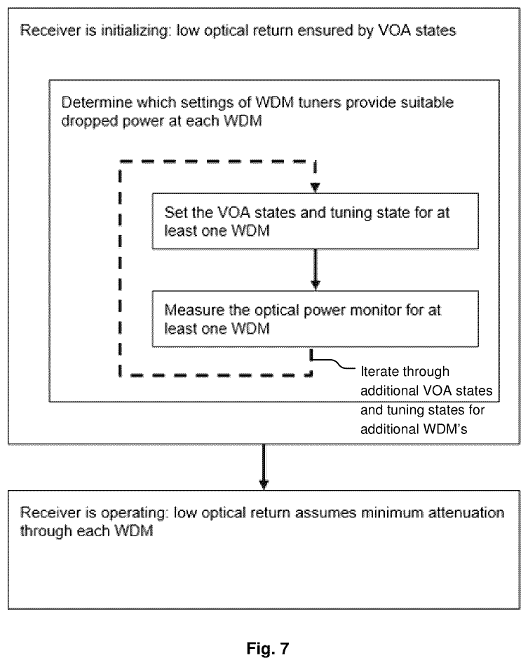

FIG. 7 shows a flowchart of a method for initializing the electro-optic receiver 100, and for then putting the electro-optic receiver 100 into normal operating mode, in accordance with some embodiments. While the electro-optic receiver 100 is initializing, return light is kept acceptably low by controlling the state(s) of the first VOA 117 and/or the second VOA 119 (even in a case where light wavelengths fall outside of the WDM element 105-1 to 105-N drop wavelength bands). While the electro-optic receiver 100 is in normal operating mode, the first VOA 117 and the second VOA 119 are respectively set by assuming that a minimum requirement for dropped optical power in the WDM elements 105-1 to 105-N is being met.

Thus, while the electro-optic receiver 100 is in normal operating mode, the optical attenuation provided by the first VOA 117 and the second VOA 119 can be set relatively low and still maintain sufficiently low return light. Also, during operation of the electro-optic receiver 100 in the normal operating mode, the settings of the first VOA 117, the second VOA 119, and the WDM elements 105-1 to 105-N can be continuously adjusted to maintain suitable photocurrent levels in the PD's 107-1 to 107-N.

During initialization, the electro-optic receiver 100 is capable of putting the first VOA 117 and the second VOA 119 into at least two operational states to ensure sufficiently low return light. In some embodiments, the electro-optic receiver 100 starts initialization in a first low-return-light VOA (117 and/or 119) state and attempts to determine which settings of the WDM element 105-1 to 105-N tuners provide a suitable drop ratio. The electro-optic receiver 100 procedurally changes the settings of the WDM element 105-1 to 105-N tuners and records a corresponding optical power monitor signal until conditions for suitable drop ratio are achieved, at which point the WDM element 105-1 to 105-N tuner setting corresponds to a wavelength component of input light falling within the tuned WDM drop band. In some embodiments, the optical power monitor signal is sampled as a function of WDM element 105-1 to 105-N tuner settings, and this functional dependence is used to estimate the dropped optical power of wavelength components of the input light.

For some polarizations of input light, the first low-return-light VOA (117 and/or 119) state may result in low optical power reaching a WDM element 105-x, which may prevent initialization of the electro-optic receiver 100 from succeeding. In this situation, the electro-optic receiver 100 is configured to retry initialization using a different low-return-light VOA (117 and/or 119) state. This process is continued iteratively, as needed, in order to determine which settings of the WDM element 105-1 to 105-N tuners provide suitable drop-ratio for each WDM element 105-1 to 105-N. Also, the polarization of input light may be different for the different wavelength components. Therefore, a VOA (117 and/or 119) setting that allows the electro-optic receiver 100 to determine suitable WDM element 105-1 to 105-N tuner (heater) settings may be different for different wavelength components. For example, some WDM element 105-1 to 105-N tuners may be characterized using a first low-return-light VOA (117 and/or 119) state, while other WDM element 105-1 to 105-N tuners may be characterized using a second low-return-light VOA (117 and/or 119) state. The electro-optic receiver 100 can iterate through several VOA (117 and/or 119) control states in order to better characterize how power monitor signals depend on WDM element 105-1 to 105-N tuners and VOA (117 and/or 119) settings.

In some embodiments, for the normal operating mode, the electro-optic receiver 100 selects operational control states for the first VOA 117 and the second VOA 119 that corresponding to low optical loss in order to maximize light detected by the PD's 107-1 to 107-N. Alternatively, in some embodiments, for the normal operating mode, the electro-optic receiver 100 selects operational control states for the first VOA 117 and the second VOA 119 that corresponding to intermediate optical loss, such that the optical power at the WDM elements 105-1 to 105-N is at a desired level. In various embodiments, the first VOA 117 and the second VOA 119 are used by the electro-optic receiver 100 in a routine for setting an appropriate optical signal level, such as for implementing gain-control, mitigating saturation or nonlinearity in the PD's 107-1 to 107-N or receiver circuitry 108-1 to 108-N, and/or otherwise improving operation of the electro-optic receiver 100. Also, in various embodiments, the first VOA 117 and/or the second VOA 119 is/are used to compensate for changes in input optical power received through the first end 101A and/or the second end of the bus optical waveguide 101, such as changes in input optical power caused by drift of laser power over time and/or drift of polarization over time.

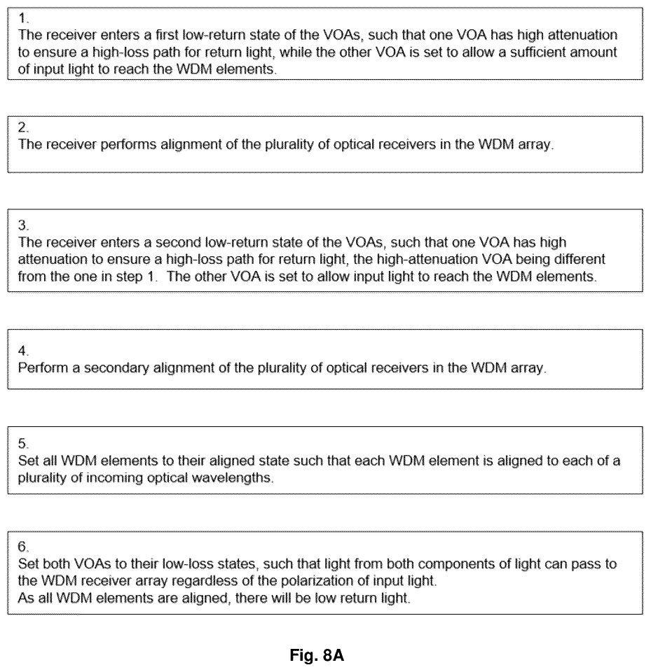

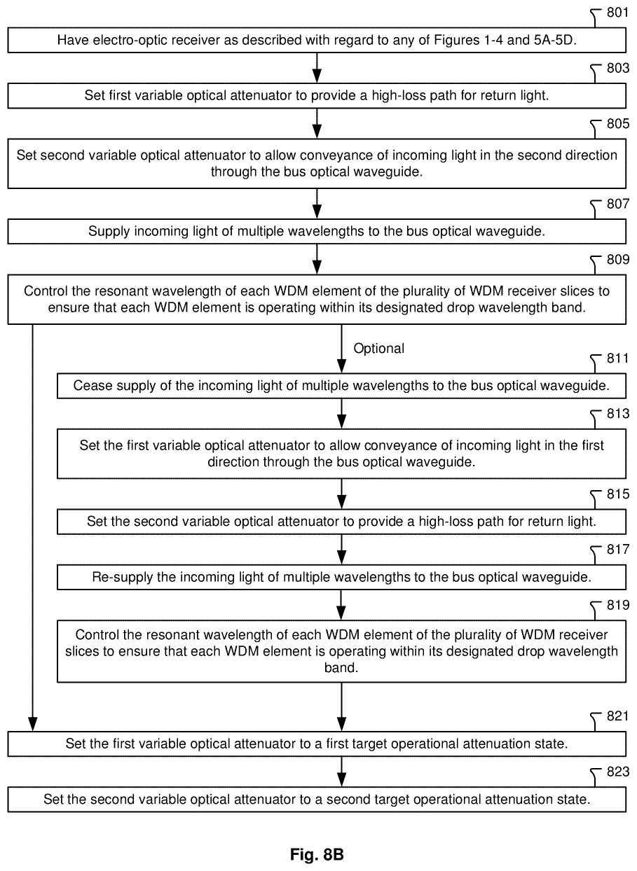

FIG. 8A shows a flowchart of a method for initializing the electro-optic receiver 100, in accordance with some embodiments. The method include a first step in which the electro-optic receiver 100 enters a first low-return-light state of the VOAs (117 and/or 119), such that one VOA (117 or 119) has high attenuation to ensure a high-loss path for return light, while the other VOA (117 or 119) is set to allow input light to reach the WDM elements 105-1 to 105-N. The method proceeds with a second step in which the electro-optic receiver 100 performs alignment of the plurality of receiver slices 103-1 to 103-N in the receiver assembly 102, e.g., in the WDM array. For example, for microring-based WDM elements 105-1 to 105-N, the second step can involve finding the thermal tuning temperature for each WDM element 105-1 to 105-N, such that each WDM element 105-1 to 105-N is aligned to a unique optical wavelength. In some embodiments, the alignment algorithm requires information about which of the two VOA's (117 or 119) was set to high-optical-loss state, in order to perform the alignment algorithm in the correct order. In an example embodiment, the alignment algorithm is performed in a WDM element-by-WDM element 105-1 to 105-N manner in a specific direction that follows the path of incoming light from the un-occluded input (or specifically in the reverse order), to ensure that no WDM element 105-1 to 105-N occludes a subsequent WDM element 105-1 to 105-N during initialization.

The method continues with a third step in which the electro-optic receiver 100 enters a second low-return state of the VOA's (117 and/or 119), such that one VOA (117 or 119) has high attenuation to ensure a high-loss path for return light, where the high-attenuation VOA (117 or 119) in the third step is different from the high-attenuation VOA (117 or 119) in the first step. Also, in the third step, the other VOA (117 or 119) is set to allow input light to reach the WDM elements 105-1 to 105-N. The method continues with a fourth step in which the electro-optic receiver 100 performs a secondary alignment of the plurality of receiver slices 103-1 to 103-N in the receiver assembly 102, e.g., in the WDM array. This alignment step may follow a substantially similar algorithm as followed in the second step. Alternatively, this alignment step can use the alignment information from the second step to perform a more informed alignment procedure. In some embodiments, this alignment step can be skipped if the alignment in the second step successfully aligned all of the WDM elements 105-1 to 105-N.

The method continues with a fifth step for setting all of the WDM elements 105-1 to 105-N to their aligned state, such that each WDM element 105-1 to 105-N is aligned to a respective one of a plurality of incoming optical wavelengths. The method continues with a sixth step for setting both the first VOA 117 and the second VOA 119 to their low-loss states, such that light from both components of light can pass to the WDM receiver assembly 102 (array) regardless of the polarization of input light. It should be noted that because all WDM elements 105-1 to 105-N are aligned, there will be low return light. The method of FIG. 8A is implemented in such a way that transient high-return-light states are avoided while the VOA (117 and/or 119) state is in transition. For example, in order to ensure low optical return during transitions, a transition to a target VOA (117 and/or 119) state may be performed in two steps: 1) first, both the first VOA 117 and the second VOA 119 are brought into a high-loss state, and 2) second, the first VOA 117 and the second VOA 119 are transitioned to their respective target state. In some embodiments, VOA (117 and/or 119) transitions are performed gradually, such that the optical power seen at each WDM element 105-1 to 105-N is attenuated in a controlled manner.

FIG. 8B shows a flowchart of a method for initializing the electro-optic receiver 100, in accordance with some embodiments. The method includes an operation 801 for having the electro-optic receiver 100, as described with regard to any of FIGS. 1, 2, 3, 4, 5A, 5B, 5C, and 5D. The method also includes an operation 803 for setting the first variable optical attenuator 117 to provide a high-loss path for return light. The method proceeds from the operation 803 with an operation 805 for setting the second variable optical attenuator 119 to allow conveyance of incoming light in the second direction through the bus optical waveguide 101. The method proceeds from the operation 805 with an operation 807 for supplying incoming light of multiple wavelengths to the bus optical waveguide 101. The method proceeds from the operation 807 with an operation 809 for controlling the resonant wavelength of each WDM element 105-1 to 105-N of the plurality of WDM receiver slices 103-1 to 103-N to ensure that each WDM element 105-1 to 105-N is operating within its designated drop wavelength band. In some embodiments, the method proceeds from the operation 809 to an operation 821 for setting the first variable optical attenuator 117 to a first target operational attenuation state. The method proceeds from the operation 821 with an operation 823 for setting the second variable optical attenuator 119 to a second target operational attenuation state.

In some embodiments, the method optionally proceeds from the operation 809 with an operation 811 for ceasing supply of the incoming light of multiple wavelengths to the bus optical waveguide 101. The method proceeds from the operation 811 with an operation 813 for setting the first variable optical attenuator 117 to provide a high-loss path for return light. In some embodiments, the operation 811 is not performed, and the method proceeds from the operation 809 to the opration 813. The method proceeds from the operation 813 with an operation 815 for setting the second variable optical attenuator 119 to allow conveyance of incoming light in the first direction through the bus optical waveguide 101. If needed, e.g., if the operation 811 was performed to cease supply of incoming light, the method proceeds from the operation 815 with an operation 817 for re-supplying the incoming light of multiple wavelengths to the bus optical waveguide 101. Otherwise, the operation 817 is not performed.

The method proceeds from the operation 815, or optionally 817, to an operation 819 for controlling the resonant wavelength of each WDM element 105-1 to 105-N of the plurality of WDM receiver slices 103-1 to 103-N to ensure that each WDM element 105-1 to 105-N is operating within its designated drop wavelength band. From the operation 819, the method proceeds with the operation 821 for setting the first variable optical attenuator 117 to a first target operational attenuation state, and then with the operation 823 for setting the second variable optical attenuator 119 to a second target operational attenuation state.

In some embodiments, the methods of FIGS. 7, 8A, and 8B are implemented at least in-part using an application specific integrated circuit (ASIC), such that at least portions of the methods are performed by dedicated circuits that are part of the electro-optic receiver 100 apparatus.

To achieve compact delay lines within the electro-optic receiver 100, it is advantageous to use a bus optical waveguide 101 with an average group velocity (vg,bus) much larger than the average group velocity of delay lines (vg,delay). For example, if the bus optical waveguide 101 is formed primarily as a silicon nitride optical waveguide and the delay lines are formed as silicon strip optical waveguides, then the ratio of [(vg,delay)/(vg,bus)] can be substantially less than one (1), and more compact delay lines can be used. More specifically, in some embodiments, the ratio of [(vg,delay)/(vg,bus)] should be less than 0.8, and more preferably should be less that 0.6. In some embodiments, if the bus optical waveguide 101 is formed mostly as a wide silicon nitride optical waveguide, a value of [1/(vg,bus)] of about 0.00718picosecond/micrometer is achievable. In some embodiments, the bus optical waveguide 101 is composed of different sections having substantially different group velocity. In these embodiments, the total delay is the sum of the delays of the sections making up the bus optical waveguide 101. Also, in these embodiments, the average group velocity (vg,bus) is defined to satisfy the condition tbus=ΔL_{bus}/(vg,bus) over a relevant length ΔLbus of the bus optical waveguide 101, where tbus is the optical delay over the relevant length ΔLbus.

In general, even if a process supports silicon and silicon nitride optical waveguides on the same photonic integrated circuit (PIC), optical coupling to a silicon microring will be implemented as evanescent coupling from a silicon optical waveguide. In some embodiments, in order to keep the bus optical waveguide 101 delay small, the bus optical waveguide 101 can be formed as silicon nitride optical waveguide over most of its length and have short sections of silicon optical waveguide in the microring optical coupling regions associated with the WDM elements 105-1 to 105-N, with tapers or MMIs used to efficiently couple light between the silicon nitride optical waveguide and the silicon optical waveguide sections. Alternatively, in some embodiments, the bus optical waveguide 101 is formed as a silicon nitride optical waveguide over most of its length, with optical coupling regions providing optical coupling directly from the silicon nitride optical waveguide to the microrings of the WDM elements 105-1 to 105-N.

In some embodiments, if the fabrication process supports only one optical waveguide material, e.g., silicon, for forming both the bus optical waveguide 101 and the delay lines (109-1 to 109-N and 111-1 to 111-N), the geometries of the bus optical waveguide 101 and the delay lines (109-1 to 109-N and 111-1 to 111-N) are engineered to produce a ratio of [(vg,delay)/(vg,bus)] that is substantially less than one (1). In some embodiments, different widths are used for the bus optical waveguide 101 and the delay lines (109-1 to 109-N and 111-1 to 111-N). For example, the group velocity of the fundamental mode of a strip optical waveguide increases with the width of the strip optical waveguide. Therefore, a wider optical waveguide is used for the bus optical waveguide 101, and narrower waveguides are used for the delay lines (109-1 to 109-N and 111-1 to 111-N). In some embodiments, different optical waveguide modes are used in the bus optical waveguide 101 and the delay lines (109-1 to 109-N and 111-1 to 111-N). For example, the fundamental mode of a multimode strip optical waveguide has a higher group velocity than the higher order modes of the multimode strip optical waveguide. Therefore, a higher order mode is used in the optical waveguides for the delay lines (109-1 to 109-N and 111-1 to 111-N), and the fundamental mode is used in the bus optical waveguide 101. In some embodiments, a slow-light metamaterial optical waveguide is used for the delay lines (109-1 to 109-N and 111-1 to 111-N), and a regular strip optical waveguide is used for the bus optical waveguide 101. When operating near the bandgap, periodically structured metamaterial optical waveguides can have significantly lower group velocity than regular uniform optical waveguides.

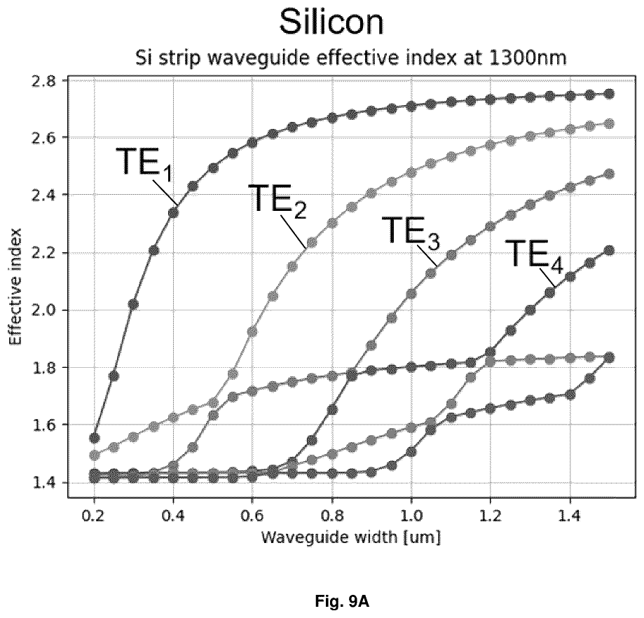

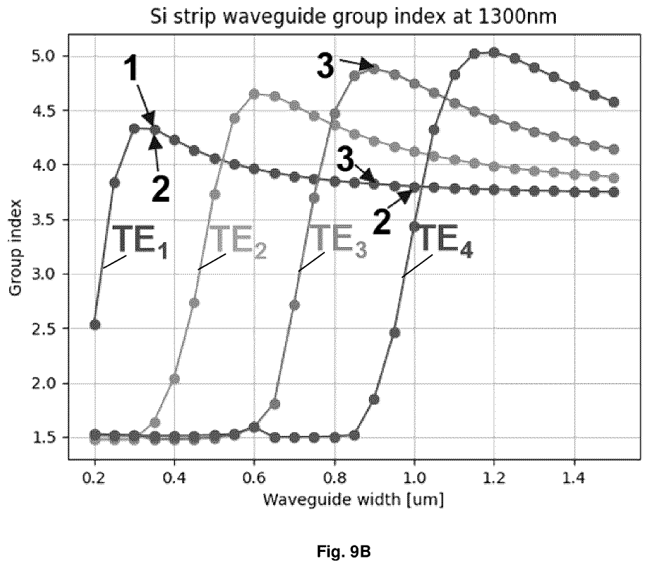

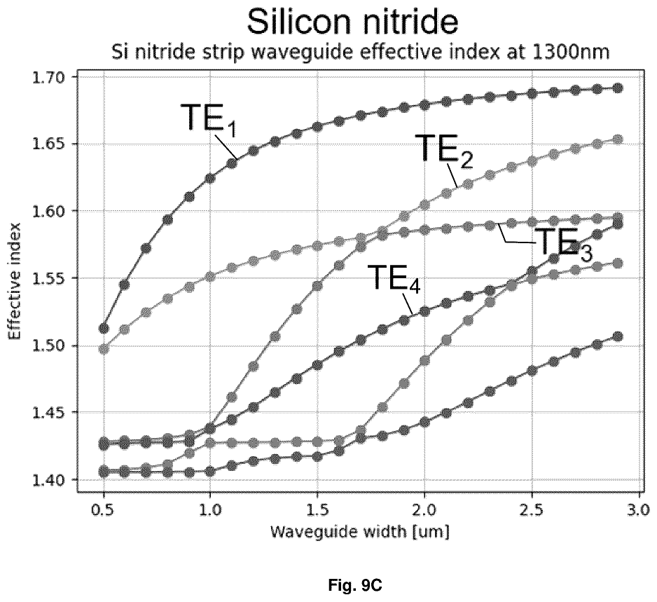

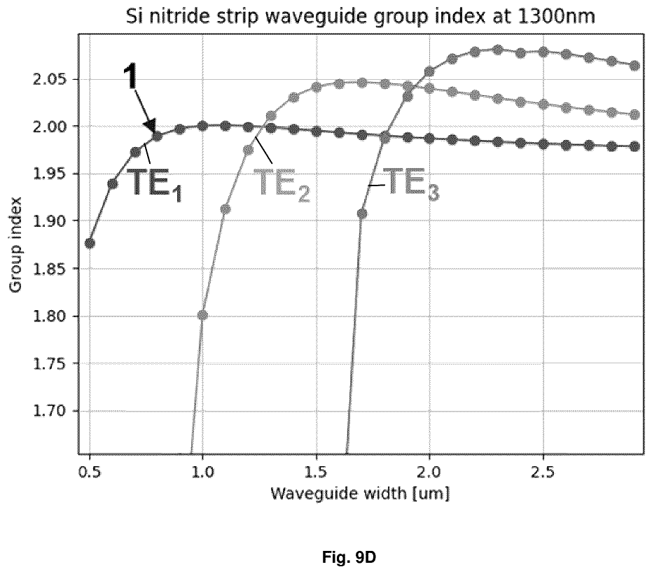

FIG. 9A shows plots of the effective index for a silicon strip optical waveguide as a function of optical waveguide width for various polarization (TE) modes (TE₁, TE₂, TE₃, and TE₄), in accordance with some embodiments. FIG. 9B shows plots of the group index for a silicon strip optical waveguide as a function of optical waveguide width for various polarization (TE) modes (TE₁, TE₂, TE₃, and TE₄), in accordance with some embodiments. FIG. 9C shows plots of the effective index for a silicon nitride strip optical waveguide as a function of optical waveguide width for various polarization (TE) modes (TE₁, TE₂, TE₃, and TE₄), in accordance with some embodiments. FIG. 9D shows plots of the group index for a silicon nitride strip optical waveguide as a function of optical waveguide width for various polarization (TE) modes (TE₁, TE₂, and TE₃), in accordance with some embodiments. The effective index plots of FIGS. 9A and 9C, and the group index plots of 9B and 9D can be used to determine a configuration of the bus optical waveguide 101 and the delay line optical waveguides (109-1 to 109-N and 111-1 to 111-N) that provides a desired difference in group velocity between the bus optical waveguide 101 and the delay line waveguides (109-1 to 109-N and 111-1 to 111-N).

In a first example configuration of the electro-optic receiver 100, using the plots of FIGS. 9A-9D, the bus optical waveguide 101 is formed of silicon nitride and has a width of 800 nanometer (nm) and a TE1 optical mode. Also, in this first example configuration of the electro-optic receiver 100, the delay line waveguides (109-1 to 109-N and 111-1 to 111-N) are formed of silicon and have a width of 350 nm and a TE1 optical mode. In this first example configuration of the electro-optic receiver 100, the ratio [(vg,delay)/(vg,bus)] is approximately 0.46.

In a second example configuration of the electro-optic receiver 100, using the plots of FIGS. 9A-9D, the bus optical waveguide 101 is formed of silicon and has a width of 1 micrometer and a TE1 optical mode. Also, in this second example configuration of the electro-optic receiver 100, the delay line waveguides (109-1 to 109-N and 111-1 to 111-N) are formed of silicon and have a width of 350 nm and a TE1 optical mode. In this second example configuration of the electro-optic receiver 100, the ratio [(vg,delay)/(vg,bus)] is approximately 0.88.

In a third example configuration of the electro-optic receiver 100, using the plots of FIGS. 9A-9D, the bus optical waveguide 101 is formed of silicon and has a width of 900 nm and a TE1 optical mode. Also, in this third example configuration of the electro-optic receiver 100, the delay line waveguides (109-1 to 109-N and 111-1 to 111-N) are formed of silicon and have a width of 900 nm and a TE3 optical mode. In this third example configuration of the electro-optic receiver 100, the ratio [(vg,delay)/(vg,bus)] is approximately 0.79.

The above-described first, second, and third example configurations of the electro-optic receiver 100 use only TE polarization. However, it should be understood that in various other embodiments of the electro-optic receiver 100, TM polarization can be used to achieve a desired group velocity mismatch. Also, in various embodiments, one or more polarization rotator(s) can be implemented within the electro-optic receiver 100 to optically connect an optical waveguide configured to provide TM-guided light to an optical waveguide configured to provide TE-guided light, and vice-versa. For example, in some embodiments of the electro-optic receiver 100 the microring optical coupling regions are configured for TE-guided light, while the bus optical waveguide 101 and/or the delay line waveguides (109-1 to 109-N and 111-1 to 111-N) are configured for TM-guided light.

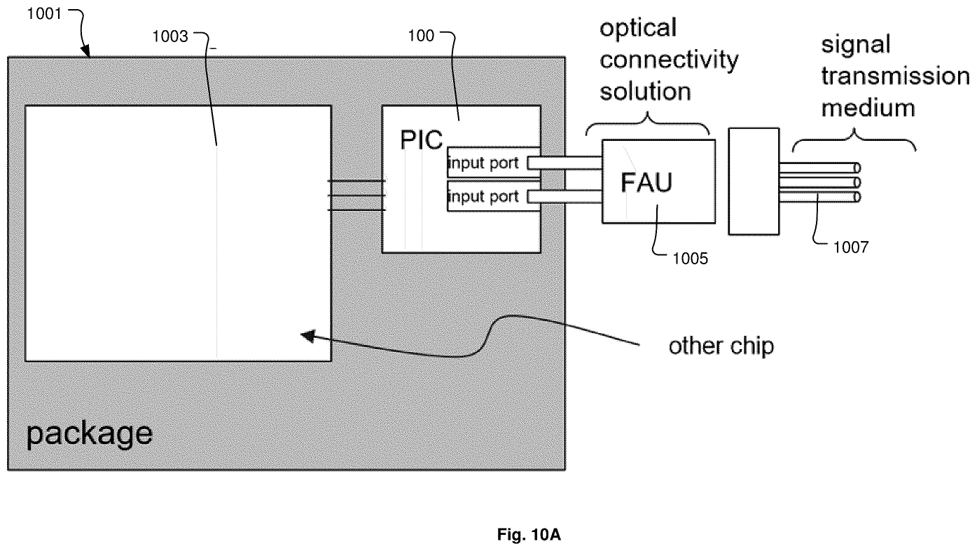

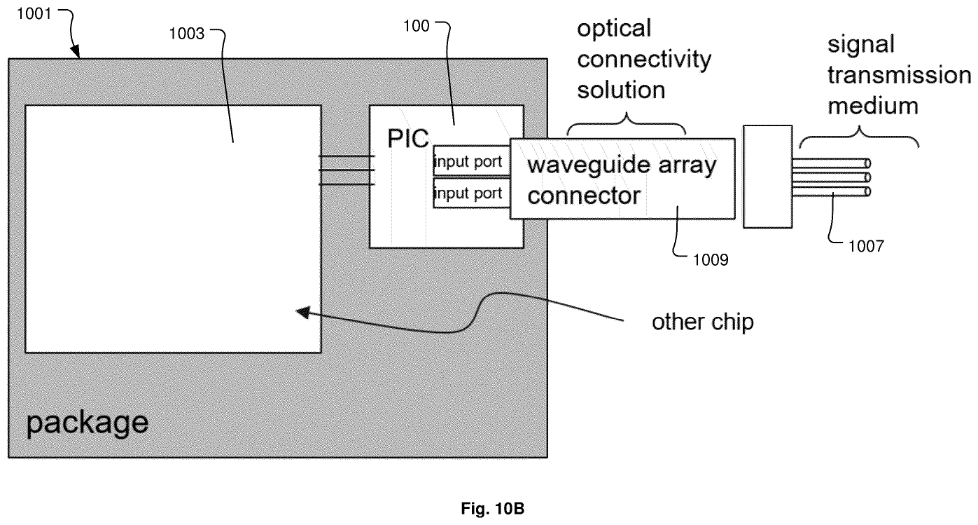

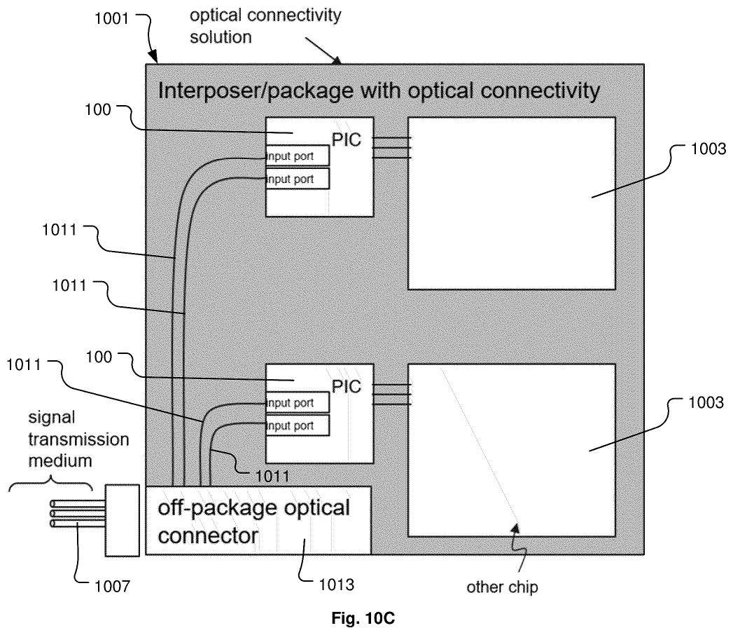

FIG. 10A shows a top view of the electro-optic receiver 100 incorporated into a co-packaged assembly 1001, in accordance with some embodiments. In some embodiments, the electro-optical receiver 100 is implemented within a PIC. In some embodiments, the co-packaged assembly 1001 includes electrical connections extending between the electro-optical receiver 100 within the PIC to another chip 1003 within the co-packaged assembly 1001, as needed. In various embodiments, the other chip 1003 is a field programmable gate array (FPGA) chip, a central processing unit (CPU) chip, a graphical processing unit (GPU) chip, or any other type of computer chip designed to perform computation. The co-packaged assembly 1001 is also configured to optically interface with an optical connectivity solution in order to optically couple light into the electro-optic receiver 100 from outside of the co-packaged assembly 1001. In the example of FIG. 10A, the optical connectivity solution of the co-packaged assembly 1001 is a fiber-attach unit (FAU) 1005 configured to provide for direct attachment of optical fibers to the PIC that includes the electro-optic receiver 100. In various embodiments, light is optical coupled into the FAU 1005 from an optical signal transmission medium. In the example of FIG. 10A, the optical signal transmission medium is an array of optical fibers 1007. However, in other embodiments, the optical signal transmission medium is one or more of an optical backplane, one or more polymer optical waveguide(s), and a free-space optical link, among other types of optical signal transmission devices. The light propagating in the optical signal transmission medium can have substantially uncontrolled polarization, or have a significant degree of polarization crosstalk, such that polarization-diversity is desirable in the electro-optic receiver 100.

FIG. 10B shows the co-packaged assembly 1001, with the optical connectivity solution implemented as an optical waveguide array connector 1009 that is directly optically connected to the electro-optic receiver 100 in the PIC, in accordance with some embodiments. In various embodiments, the optical waveguide array connector includes one or more of oxide materials, nitride materials, semiconductor materials, or polymer materials.

FIG. 10C shows the co-packaged assembly 1001, with the optical connectivity solution built into the co-packaged assembly 101 using an interposer or other packaging component that incorporates optical waveguides and optical couplers, as needed, in accordance with some embodiments. In some embodiments, optical connections 1011, such as optical waveguides and/or optical fibers, are used to optically connect one or more electro-optic receiver 100 PIC(s) to an off-package optical connector 1013 of the co-packaged assembly 1001.

The foregoing description of the embodiments has been provided for purposes of illustration and description, and is not intended to be exhaustive or limiting. Individual elements or features of a particular embodiment are generally not limited to that particular embodiment, but, where applicable, are interchangeable and can be used in a selected embodiment, even if not specifically shown or described. In this manner, one or more features from one or more embodiments disclosed herein can be combined with one or more features from one or more other embodiments disclosed herein to form another embodiment that is not explicitly disclosed herein, but rather that is implicitly disclosed herein. This other embodiment may also be varied in many ways. Such embodiment variations are not to be regarded as a departure from the disclosure herein, and all such embodiment variations and modifications are intended to be included within the scope of the disclosure provided herein.

Although some method operations may be described in a specific order herein, it should be understood that other housekeeping operations may be performed in between method operations, and/or method operations may be adjusted so that they occur at slightly different times or simultaneously or may be distributed in a system which allows the occurrence of the processing operations at various intervals associated with the processing, as long as the processing of the method operations are performed in a manner that provides for successful implementation of the method.

Although the foregoing embodiments have been described in some detail for purposes of clarity of understanding, it will be apparent that certain changes and modifications can be practiced within the scope of the appended claims. Accordingly, the embodiments disclosed herein are to be considered as illustrative and not restrictive, and are therefore not to be limited to just the details given herein, but may be modified within the scope and equivalents of the appended claims.

What is claimed is:

1. An electro-optic receiver, comprising:
a bus optical waveguide;
a plurality of wavelength division multiplexing (WDM) receiver slices positioned along the bus optical waveguide,
wherein each of the plurality of WDM receiver slices includes a WDM element optically coupled to the bus optical waveguide,
wherein each of the plurality of WDM receiver slices also includes a photodetector, wherein the photodetector of a given WDM receiver slice is optically connected to the WDM element of the given WDM receiver slice by both a first optical connection and a second optical connection, wherein the WDM element of the given WDM receiver slice is configured to convey a first component of input light traveling through the bus optical waveguide in a first direction through the first optical connection to the photodetector, and wherein the WDM element of the given WDM receiver slice is configured to convey a second component of input light traveling through the bus optical waveguide in a second direction through the second optical connection to the photodetector, wherein the second direction is opposite of the first direction, and
wherein each of the plurality of WDM receiver slices also includes a receiver circuit, wherein the receiver circuit of a given WDM receiver slice is electrically connected to receive a photocurrent from the photodetector of the given WDM receiver slice, wherein the receiver circuit of the given WDM receiver slice is configured to generate an electrical data signal from the photocurrent.

2. The electro-optic receiver as recited in claim 1, wherein the WDM element has a drop wavelength band, such that input light traveling through the bus optical waveguide in either direction of travel that has a wavelength within the drop wavelength band is optically coupled by the WDM element into the WDM receiver slice that includes the WDM element.

3. The electro-optic receiver as recited in claim 1, wherein the plurality of WDM receiver slices are implemented together on a monolithically integrated chip.

4. The electro-optic receiver as recited in claim 1, wherein the WDM elements and the photodetectors of the plurality of WDM receiver slices are implemented on an integrated photonics chip, and the receiver circuits of the plurality of WDM receiver slices are implemented on an electronics chip.

5. The electro-optic receiver as recited in claim 4, wherein the integrated photonics chip and the electronics chip are stacked vertically with respect to each other, with electrical connections made vertically between the integrated photonics chip and the electronics chip.

6. The electro-optic receiver as recited in claim 1, wherein the plurality of WDM receiver slices collectively form a receiver assembly that has a first end and a second end, wherein the electro-optic receiver further includes a first variable optical attenuator optically coupled to the bus optical waveguide at the first end of the receiver assembly, and wherein the electro-optic receiver further includes a second variable optical attenuator optically coupled to the bus optical waveguide at the second end of the receiver assembly.

7. The electro-optic receiver as recited in claim 6, further comprising:
a polarization splitter-rotator configured to convey the first component of input light through the bus optical waveguide in the first direction, the polarization splitter-rotator configured to convey the second component of input light through the bus optical waveguide in the second direction.

8. The electro-optic receiver as recited in claim 7, wherein the polarization splitter-rotator is configured to separate the first and second components of input light based on the first component of input light having a first polarization and the second component of input light having a second polarization, and wherein the polarization splitter-rotator is configured to rotate a polarization of the second component of input light from the second polarization to the first polarization, such that both the first and second components of input light traveling through the bus optical waveguide have the first polarization.

9. The electro-optic receiver as recited in claim 7, wherein an optical input of the polarization splitter-rotator is optically connected to a optical input port of a chip on which the electro-optic receiver is implemented.

10. The electro-optic receiver as recited in claim 7, further comprising:
an optical delay element optically coupled to the bus optical waveguide at a location between the polarization splitter-rotator and either the first end of the receiver assembly or the second end of the receiver assembly, wherein the optical delay element is configured to mitigate an optical signal timing skew present at the photodetectors of the plurality of WDM receiver slices within the receiver assembly, wherein the optical signal timing skew is a difference in arrival time at a given photodetector between a particular wavelength of the first component of input light derived from a given portion of incoming light and the same particular wavelength of the second component of input light derived from the same given portion of incoming light.

11. The electro-optic receiver as recited in claim 10, wherein said optical delay element is a first optical delay element optically coupled to the bus optical waveguide at a location between the polarization splitter-rotator and the first end of the receiver assembly, and wherein the electro-optic receiver further includes a second optical delay element optically coupled to the bus optical waveguide at a location between the polarization splitter-rotator and the second end of the receiver assembly, wherein the first optical delay element and the second optical delay element are collectively configured to mitigate the optical signal timing skew present at the photodetectors of the plurality of WDM receiver slices within the receiver assembly.

12. The electro-optic receiver as recited in claim 6, wherein the first variable optical attenuator has a folded configuration, such that a first portion of the first variable optical attenuator extends in a first direction, and such that a second portion of the first variable optical attenuator extends in a second direction opposite the first direction, wherein the first and second directions are substantially parallel to a linear direction of the bus optical waveguide extending through the receiver assembly, and wherein the second variable optical attenuator has a linear configuration extending in the first direction.

13. The electro-optic receiver as recited in claim 12, wherein the first variable optical attenuator is disposed between the second variable optical attenuator an the receiver assembly.

14. The electro-optic receiver as recited in claim 12, wherein an optical input of the first variable optical attenuator and an optical input of the second variable optical attenuator are positioned on a same side of the receiver assembly.

15. The electro-optic receiver as recited in claim 12, wherein an optical path length of the first portion of the first variable optical attenuator is substantially equal to an optical path length of the second portion of the first variable optical attenuator.

16. The electro-optic receiver as recited in claim 12, wherein a combined total optical path length of the first and second portions of the first variable optical attenuator is substantially equal to a total optical path length of the second variable optical attenuator.

17. The electro-optic receiver as recited in claim 16, wherein an optical path length of the first portion of the first variable optical attenuator is substantially equal to an optical path length of the second portion of the first variable optical attenuator.

18. The electro-optic receiver as recited in claim 12, further comprising:
a first power monitor block implemented along the bus optical waveguide between the first variable optical attenuator and the first end of the receiver assembly, the first power monitor block configured to determine an amount of optical power traveling in each direction through the bus optical waveguide at the first end of the receiver assembly; and
a second power monitor block implemented along the bus optical waveguide between the second variable optical attenuator and the second end of the receiver assembly, the second power monitor block configured to determine an amount of optical power traveling in each direction through the bus optical waveguide at the second end of the receiver assembly.

19. The electro-optic receiver as recited in claim 18, wherein the first power monitor block includes a first broadband optical power tap optically coupled to the bus optical waveguide, the first power monitor block including a first photodetector optically connected to the first broadband optical power tap to detect an amount of light traveling through the bus optical waveguide in the first direction, the first power monitor block including a second photodetector optically connected to the first broadband optical power tap to detect an amount of light traveling through the bus optical waveguide in the second direction, the first power monitor block including circuitry for processing photocurrents from the first photodetector and the second photodetector,
wherein the second power monitor block includes a second broadband optical power tap optically coupled to the bus optical waveguide, the second power monitor block including a third photodetector optically connected to the second broadband optical power tap to detect an amount of light traveling through the bus optical waveguide in the first direction, the second power monitor block including a fourth photodetector optically connected to the second broadband optical power tap to detect an amount of light traveling through the bus optical waveguide in the second direction, the second power monitor block including circuitry for processing photocurrents from the third photodetector and the fourth photodetector.

20. The electro-optic receiver as recited in claim 18, further comprising:
feedback logic configured to generate and transmit electrical control signals to each of the first variable optical attenuator and the second variable optical attenuator to set overall optical power levels reaching the WDM elements within the plurality of WDM receiver slices of the receiver assembly.

21. The electro-optic receiver as recited in claim 1, wherein one or more of the plurality of WDM receiver slices includes an optical signal delay element on the first optical connection between the WDM element and the photodetector of said one or more of the plurality of WDM receiver slices, and wherein one or more of the plurality of WDM receiver slices includes another optical signal delay element on the second optical connection between the WDM element and the photodetector of said one or more of the plurality of WDM receiver slices.

22. The electro-optic receiver as recited in claim 1, wherein the WDM elements of the plurality of WDM receiver slices are disposed together on an integrated photonics chip, with the photodetectors and receiver circuits of the plurality of WDM receiver slices disposed apart from the WDM elements.

23. The electro-optic receiver as recited in claim 22, wherein, for each of the plurality of WDM receiver slices, an optical path length of the first optical connection between the WDM element and the photodetector is substantially equal to an optical path length of the second optical connection between the WDM element and the photodetector.

24. The electro-optic receiver as recited in claim 23, further comprising:
resonant wavelength tuning circuits respectively implemented on the integrated photonics chip for each WDM element of the plurality of WDM receiver slices, wherein the receiver circuit of each WDM receiver slice is configured to generate and transmit a control signal for controlling the resonant wavelength tuning circuit for the WDM element of said each WDM receiver slice.

25. The electro-optic receiver as recited in claim 24, wherein the resonant wavelength tuning circuit for a given WDM element includes a heating device in thermal communication with the given WDM element.

26. The electro-optic receiver as recited in claim 1, wherein the WDM elements of the plurality of WDM receiver slices are disposed together on an integrated photonics chip, with the receiver circuits of the plurality of WDM receiver slices disposed apart from the WDM elements on the integrated photonics chip, wherein the photodetectors of the plurality of WDM receiver slices are disposed together with the corresponding WDM elements on the integrated photonics chip, with the receiver circuits of the plurality of WDM receiver slices also disposed apart from the photodetectors on the integrated photonics chip.

27. The electro-optic receiver as recited in claim 26, further comprising:
front-end circuits respectively implemented on the integrated photonics chip for each photodetectors of the plurality of WDM receiver slices, the front-end circuits configured to provide for substantially instantaneous transmission of electrical signals from the photodetectors to the corresponding receiver circuits of the plurality of WDM receiver slices.

28. The electro-optic receiver as recited in claim 27, wherein each of the front-end circuits includes a transimpedance amplifier and an analog-to-digital converter.

29. The electro-optic receiver as recited in claim 27, wherein the WDM elements and the corresponding photodetectors are positioned in a substantially uniform azimuthal arrangement about a central region.

30. An optical signal delay device, comprising:
an optical waveguide having a spiral configuration, the spiral configuration having an overall shape that is substantially rectangular as defined by a width and a length that is substantially larger than the width, wherein adjacently positioned portions of the optical waveguide within the spiral configuration are configured to have an optical index-mismatch of sufficient amount so as to substantially mitigate optical signal crosstalk between the adjacently positioned portions of the optical waveguide.

31. The optical signal delay device as recited in claim 30, wherein the optical waveguide has an input end and an output end, wherein the input end and the output end are positioned next to each other at an outer perimeter of the spiral configuration.

32. The optical signal delay device as recited in claim 31, wherein a first half of the optical waveguide runs parallel and adjacent to a second half of the optical waveguide around the spiral configuration, and wherein a midpoint of an overall optical path length of the optical waveguide is located at a center of the spiral configuration.

33. The optical signal delay device as recited in claim 30, wherein adjacently positioned portions of the optical waveguide have different widths to achieve the optical index-mismatch.

34. The optical signal delay device as recited in claim 33, wherein the optical waveguide includes tapers to transition between different widths along an optical path length of the optical waveguide.

35. A method for initializing an electro-optic receiver, comprising:
having an electro-optic receiver that includes a bus optical waveguide and a plurality of wavelength division multiplexing (WDM) receiver slices positioned along the bus optical waveguide, wherein each of the plurality of WDM receiver slices includes a WDM element optically coupled to the bus optical waveguide,
wherein each of the plurality of WDM receiver slices also includes a photodetector, wherein the photodetector of a given WDM receiver slice is optically connected to the WDM element of the given WDM receiver slice by both a first optical connection and a second optical connection, wherein the WDM element of the given WDM receiver slice is configured to convey a first component of input light traveling through the bus optical waveguide in a first direction through the first optical connection to the photodetector, and wherein the WDM element of the given WDM receiver slice is configured to convey a second component of input light traveling through the bus optical waveguide in a second direction through the second optical connection to the photodetector, wherein the second direction is opposite of the first direction,
wherein each of the plurality of WDM receiver slices also includes a receiver circuit, wherein the receiver circuit of a given WDM receiver slice is electrically connected to receive a photocurrent from the photodetector of the given WDM receiver slice, wherein the receiver circuit of the given WDM receiver slice is configured to generate an electrical data signal from the photocurrent,
wherein the plurality of WDM receiver slices collectively form a receiver assembly that has a first end and a second end, wherein the electro-optic receiver further includes a first variable optical attenuator optically coupled to the bus optical waveguide at the first end of the receiver assembly, and wherein the electro-optic receiver further includes a second variable optical attenuator optically coupled to the bus optical waveguide at the second end of the receiver assembly;
setting the first variable optical attenuator to provide a high-loss path for return light;
setting the second variable optical attenuator to allow conveyance of incoming light in the second direction through the bus optical waveguide;
supplying incoming light of multiple wavelengths to the bus optical waveguide; and
controlling the resonant wavelength of each WDM element of the plurality of WDM receiver slices to ensure that each WDM element is operating within its designated drop wavelength band.

36. The method as recited in claim 35, further comprising:
setting the first variable optical attenuator to a first target operational attenuation state; and
setting the second variable optical attenuator to a second target operational attenuation state.

37. The method as recited in claim 35, further comprising:
setting the first variable optical attenuator to allow conveyance of incoming light in the first direction through the bus optical waveguide;
setting the second variable optical attenuator to provide a high-loss path for return light; and
controlling the resonant wavelength of each WDM element of the plurality of WDM receiver slices to ensure that each WDM element is operating within its designated drop wavelength band.

38. The method as recited in claim 37, further comprising:
setting the first variable optical attenuator to provide a high-loss path for return light;
setting the second variable optical attenuator to allow conveyance of incoming light in the first direction through the bus optical waveguide; and
controlling the resonant wavelength of each WDM element of the plurality of WDM receiver slices to ensure that each WDM element is operating within its designated drop wavelength band.

39. The method as recited in claim 38, further comprising:
setting the first variable optical attenuator to a first target operational attenuation state; and
setting the second variable optical attenuator to a second target operational attenuation state.
